(19) United States
(12) Patent Application Publication
(10) Pub. No.: US 2024/0380802 A1
(43) Pub. Date: Nov. 14, 2024

(54) Hybrid Human - A.I Machine Learing via Peer Review and Embedded Continual Assessment

(71) Applicant: Susan (Zann) Gill, Los Altos, CA (US)

(72) Inventor: Susan (Zann) Gill, Los Altos, CA (US)

(73) Assignee: Susan (Zann) Gill, Los Altos, CA (US)

(21) Appl. No.: 18/782,263

(22) Filed: Jul. 24, 2024

Related U.S. Application Data
(63) Continuation-in-part of application No. 17/492,479, filed on Oct. 1, 2021, now abandoned.
(63) Continuation-in-part of application No. 14/133,235, filed on Dec. 18, 2013, now Pat. No. 9,712,576.
Application No. 14/133,235 is a continuation of application No. 12/817,167, filed on Jun. 16, 2010, now Pat. No. 8,639,650.
Application No. 12/817,167 is a continuation-in-part of application No. 11/733,736, filed on Apr. 10, 2007, now Pat. No. 7,853,551.
Application No. 11/733,736 is a continuation-in-part of application No. 10/602,824, filed on Jun. 25, 2003, now abandoned.
(60) Provisional application No. 60/391,861, filed on Jun. 25, 2002.

(51) Int. Cl. H04L 65/403; G06F 3/04817; G06F 16/28; G06N 5/04; G06Q 10/0631; G06Q 10/101; G06Q 30/0601

(52) U.S. Cl. CPC H04L 65/403; G06F 3/04817; G06F 16/285; G06N 5/04; G06Q 10/06311; G06Q 10/101; G06Q 30/0611

(57) ABSTRACT

A hybrid human-A.I. recommender system based on IDs, described by their tags, said system comprising: a processor; a non-transitory storage element coupled to the processor; encoded instructions stored in the non-transitory storage element, wherein the encoded instructions when implemented by the processor, configure the system to: assemble meta-data tags for every user, content item, resource, action, procedure, timestamp, or geo-location into a machine-readable identifier (ID), wherein each ID comprises a signature of registration tags added by the user and editable anytime, and a timestamp, location stamp, and any other tags added by the system at the time the action is performed in the system, and said ID comprises a footprint of continually accruing tags, added as users contribute and use items in the system. The system timestamps every entry, computes and updates the tag strength profile for each ID, making recommendations to each user based on the tag strength profile of that user's ID to other IDs, weighted by other factors.

### CROSS REFERENCE TO RELATED APPLICATIONS

This application is a continuation of co-pending U.S. patent application entitled Crowd-Sourced Project and Transaction Management System For Human- And Device-Adaptive Requester-Provider Networks (Ser. No. 14/133,235), which is a continuation of issued U.S. Pat. No. 8,639,650 B1 entitled “Profile-Responsive System for Information Exchange in Human- and Device-Adaptive Query-Response Networks for Task and Crowd Management. Distributed Collaboration and Data Integration, Ser. No. 12/817,167 filed on Jun. 16, 2010, which is a continuation-in-part of U.S. patent application entitled “Natural Language Knowledge Processor Using TRACE Or Other Cognitive Process Models”, Ser. No. 11/733,736 filed on Apr. 10, 2007, which is a continuation-in-part of U.S. patent application entitled “TRACE Cognitive Process Model And Knowledge Processor”, Ser. No. 10/602,824, filed on Jun. 25, 2003 which claims priority from U.S. Provisional Patent Application No. 60/391,861 filed on Jun. 25, 2002 and also claims priority from U.S. Provisional Patent Application No. 61/187,485 filed on Jun. 16, 2009, and incorporates those applications herein by reference for all purposes.

### FIELD OF INVENTION

The invention describes a crowdsourced platform for annotating online audio and video media using diverse devices where interest groups grow and evolve around key topics, such that human users tagging and classifying, rating, and scoring content, train a machine learning Intelligent Integrating System (IIS) to supports distributed media annotation, learning, and delivery of recommendations through a hybrid human-AI recommender system.

### BACKGROUND

The current digital media landscape is overwhelmed by a vast amount of online audio and video content, including forums, presentations, films, and podcasts. More effective ways are needed to manage and annotate content, and to grow social networks for commenting, rating, sharing, using, and being rewarded for contributions to the online ecosystem, and actions in the real world that are peer reviewed and verified in the online ecosystem. Just as Uber has viability with only one car, a social network should be implementable by a small group as a single node, growing to have increasing viability and functionality as other modular nodes are added, with potential to evolve into a global problem-solving online ecosystem.

Three technology limitations need to be addressed. First, pre-training Large Language Models (LLMs), and then releasing them to perform without humans in the loop, has resulted in performance failures. In contrast, what is needed is capacity to implement human training-in-action such that the machine learns through performance, enabled by continual, ongoing feedback from human users, extending RLHF (Reinforcement Learning with Human Feedback) and RAG (Retrieval-Augmented Generation) to overcome the limitations of existing systems that rely on pre-trained models operating independently, without continual input and feedback from human users, resulting in outdated or inadequate adaptation to new information and evolving user needs. Smaller models, and more rapid iterations, mimic the rapid iterations of natural evolution. Second, both problem definition and goal-setting require consensus if more than one human is involved in a problem-solving process. Instead, what is needed is a system that allows all human agents working together to proceed without requiring consensus, much the way Wikipedia writers co-produce an article without having to convene, pre-plan, or agree. Third, conventional online search is based on the standard goal-setting model wherein keyword search terms are matched by the search engine to a predicted target (goal) of the searcher, often biased by an agenda to earn revenue from advertising. What is needed is a system to support search and discovery based on browsing and serendipitous discovery through convergence toward, and emergence of, results that were not necessarily predictable as a goal in advance.

In addition to the three ways listed in the previous paragraph, our conventional problem-solving model has two additional limitations. First, widespread emphasis on collective intelligence, which taps a crowd of anonymous responders to deliver a typically better-than-average consensus result, has neglected collaborative intelligence wherein a crowd of non-anonymous, unique, identified responders contributes to an ongoing discovery process, which does not end with a consensus result but continues to evolve through ongoing diversity of input from which each user and the ecosystem can select, as in natural evolution. Second, A.I. agents are typically designed based on an outdated three-step, goal-setting problem-solving model: First, define the problem. Second, state your goal. Third, reduce the difference between the present state and the pre-stated goal state, thereby minimizing risk by maximizing top-down control and predictability. What is needed in lieu of pre-planning, consensus, and top-down control, which dominate standard problem-solving models, is a system based on an evolutionary model wherein distributed, autonomous agents, both human and A.I., converge toward a contextually optimized innovation (goal state) without pre-stating the goal and without requiring consensus, by harnessing the collaborative autonomy of unique players as in natural evolution to achieve hybrid human-A.I. collaborative intelligence.

### SUMMARY

To address the need for a more systematic way to manage and annotate content, the subject invention is a SaaS (Software as a System) social network wherein human users, pursuing their individual human priorities for search, discovery, and record-keeping for their own work, make autonomous decisions and perform actions as users within a system framework where each unique human user operates with collaborative autonomy and, as such, is a core contributor to machine learning and system functioning by simultaneously adding and modifying annotations, and performing other actions, with human actions tracked and attributed to each user. Collaborative intelligence of many annotators, unknown to each other, does not require consensus to annotate online recordings, as when diverse authors contribute to articles for Wikipedia.

To address failures in pre-training Large Language Models (LLMs), which are then released to perform independently, the subject invention implements human training-in-action such that the machine learns through performance, enabled by continual, ongoing feedback from human users via Embedded Continual Assessment (ECA) feedback loops, extending RLHF (Reinforcement Learning with Human Feedback) and RAG (Retrieval-Augmented Generation), such that the system continually adapts and evolves based on real-time human interactions, maintaining the relevance and accuracy of its matches and recommendations. The machine, by tracking every human action, crowdsources its own training and monitoring.

To overcome limitations of traditional pre-planning and goal-setting problem-solving models, design of the subject invention structures human crowdsourcing for machine learning. The system's frontend, human user-facing graphical user interfaces (GUIs) and icons, badges rely on three elements to mediate bidirectional interactions from the GUI to backend machine processing, and vice versa, such that iterative cycles of Embedded Continual Assessment (ECA) underpin hybrid human-A.I. collaborative intelligence by engaging three bidirectional elements, tags, IDs (machine-readable identifiers comprised of tags), and nodes registered by human users (machine-readable identifiers comprised of IDs, which are comprised of tags). Structural coupling of human prompts to machine learning is mediated by graphical user interface (GUI) design such that the machine component of the subject invention, by tracking and recording human actions, crowdsources its own training and monitoring. These three elements not only provide human feedback to train and monitor the machine learning system but also enable the machine to deliver customized recommendations to its human users.

The traditional limitations of consensus-seeking are addressed in the subject invention by scorekeeping, through which impact tracking, game-like incentives, and transaction exchange functionality are provided. Crowdsourced human peer review underpins scorekeeping, which guides machine learning. Tasks are rewarded with points, as with airline miles, and the number of points received translates into tokens. Human peer reviewers perform scorekeeping by awarding icons, badges, thus conferring points to content or task performance and to its authors. Peer reviewers also receive points for their service, points not only for contributing content but also for commenting, evaluating, rating, sharing, and using, or other valued tasks that earn points, tokens, or other rewards. The system can award points to human users for both online and offline contributions with validated reports and peer review. Scorekeeping, impact tracking, and capacity to earn tokens or rewards in the system is based on peer review rating, comments, and badge points in diverse keyword categories. Points can be translated to tokens or other contributor remuneration for scorekeeping, which underpins translation of tokens to Contributor Income when defined conditions are met.

Whereas the term crowdsourcing typically connotes a central human task requester, broadcasting a single task request to a homogeneous crowd of anonymous human micro-task performers, the subject invention redefines crowdsourcing as initiated, not from central command-and-control, but as driven by distributed human users delivering, without a central task request, what the machine learning system needs to learn about its human users. Each distributed, unique, non-anonymous human user is an autonomous agent, enabled by the system to pursue his/her unique learning and discovery objectives such that human users are crowdsourced to co-design the system. Human users prompt the machine in unique ways, and the machine in turn prompts (delivers recommendations to) its human users such that ongoing iterative feedback cycles of human-A.I. co-prompting evolve toward increased human-A.I. collaborative intelligence.

The subject invention moves beyond two top-down control assumptions: first, that bigger is better, whether bigger LLMs or bigger datasets of human buyers for collaborative filtering. Huge LLMs can be more cumbersome, expensive, and subject to slower evolution, whereas smaller models can mimic natural evolution, rapidly trying many experiments, failing faster, but also adapting faster. Commercial applications of collaborative filtering in recommender systems typically have huge datasets of buyers but shallow knowledge, knowing only what customers bought, not why each customer made each decision or what each human user is trying to do. The subject invention follows user paths over time, developing deeper knowledge of user motivations to inform recommendations, which are co-developed with each user, much as a good advisor listens to a client, enabling that client to make better decisions by asking good questions that support the client's own decision-making.

### Glossary

The definitions below provide context for the three key terms, tags, IDs, and nodes and further explain how tags define IDs and how the system is designed to engage its human users to register nodes such that the machine learns from the actions and decisions of its human users.

annotation of an online recording (exemplar of a node type)—In one embodiment, human content annotation is supported by an A.I. enabled backend system that timestamps each user click while viewing an online recording, registered as an online project node for annotation; links each click timestamp to proximal keywords in the recording content at the time of the click; collects all time stamped clicks into a unique user click profile for that user ID and that content ID; and makes recommendations to that user based on that user's click profile and generates from the user's click profile a customized user interface, served to that user after the user completes watching the recording, recommending content and other resources to the user related to that user's interests, updating the user's profile ID with new tags based on this interaction. The user IDs of those who interact with an annotated recording node ID can link other IDs to that annotation node such that annotation continues, crowdsourcing the input of many users.

authenticity the subject invention, using blockchain technology and artificial intelligence, can enable artists to protect their art online using a timestamp on a blockchain to obtain a copyright certificate to prove their rights and can also be used more broadly to prove authenticity.

blockchain—a peer-to-peer, open-source, distributed database and transaction ledger that uses cutting-edge encryption and is characterized by anonymity, audibility, decentralization, fault tolerance, immutability, integrity, transparency, and verification. Blockchain, though decentralized, relies on cloud computing, which has centralization risks. Blockchain has at least eight key applications in the subject invention including, but not limited to, asset tracking, confirmation of transaction data, digital ownership, digital records, identity and reputation management, security and privacy, supply chain, and voting.

click profile—As the user watches a recording, the system tracks and timestamps each click, linking that click to relevant keywords in the recording content at the time of the click. Timestamped clicks are compiled into a unique user click profile for that user ID relative to that content item ID.

cluster—machine-assembled, complementing nodes and sub-nodes, which, with the exception keyword nodes, are registered and assembled by human users. All nodes are front-end human user facing, including keyword nodes, which are automatically registered. All clusters are backend machine-facing except when the machine recommends to a human user, based upon that user's preferences, a cluster for possible human registration as a node, such as a list of all fire-related disaster response experts in a region to a human expert in disaster response.

collaborative autonomy each agent operating independently, without top-down control or need for consensus such that, as in a thriving natural ecosystem, independent agents together manifest collaborative intelligence, e.g. independent writers producing a Wikipedia article

collaborative intelligence—comprising agents that are not anonymous, including both human contributors and non-anonymous devices, from A.I. agents to tagged sensors and geo-located devices, identified unique human contributors engaged in an ongoing collaborative problem-solving process modeled on evolution in nature where task performers have different skills, motivations, and perform different tasks in the system.

collective intelligence—processing input from a large number of anonymous responders to quantitative questions to produce a typically better-than-average prediction, a consensus result

connectivity module responsible for evaluating and managing the connections between various machine-readable identifiers (IDs), calculating relative strengths of tags in IDs to produce a tag strength profile for each ID for the recommender module and adjusting recommendations based upon exceptional tags, node affiliations and other factors.

crowdsourcing—traditionally denotes a central requester/controller, who broadcasts a task request, distributing microtasks to a crowd of anonymous task performers, collecting and processing what they deliver. In contrast, in the subject invention crowdsourcing is not managed by a central command-and-control requester. Human users are autonomous navigators, actors in the system such that what they choose informs machine learning.

customized user interface—generated from a user's click profile and customized for that unique user's preferences. Once the user finishes watching the recording, the system uses that user's click profile to generate a personalized interface, which serves to that user tailored recommendations of content, resources, and other users aligned with the user's interests. In addition, system icons and templates enable users to generate their own customized user interfaces for curriculum design and other purposes.

discoverability—All items in the system are discoverable by searching any of their tags, whether user (human or agent) ID tags, topic keyword ID tags, project ID tags, node ID tags, timestamp, geo-location, other tags or tag links to other items in the system, such that each user profile ID, content item ID, action record ID, node ID, or any other ID in the system is discoverable through matching tags in the user ID or query with tags in the discovered ID.

Embedded Continual Assessment (ECA)—human-in-the-loop continual feedback from human users extends three A.I. research threads. First, RLHF (Reinforcement Learning with Human Feedback), a technique to align an intelligent agent to human preferences by using human feedback data to train the reward model, is extended in the subject invention by crowdsourcing human preferences to deliver rewards directly, such that the machine learns from human action records. Second, A.I. alignment, an ongoing A.I. research domain, aims to steer A.I. systems toward a person's or group's intended goals, preferences, and ethical principles. In contrast, the subject invention operates without “steering” and without “goals” through direct engagement of its human users such that their choices inform machine learning. Third, RAG (Retrieval-Augmented Generation) optimizes the output of a large language model by referencing an authoritative knowledge base outside of the model's training data, typically the internal database of the enterprise where RAG is deployed, such that the LLM can be updated with accurate information and source attribution. Retrieval-augmented generation gives models updated sources to cite, like footnotes in a research paper, so users can check claims. Embedded Continual Assessment (ECA) augments RAG with more options to retrieve and cite current information from updated sources.

exceptional tags—tags with not-often-repeated data, so they do not show as highly ranked in a tag strength profile, despite conveying key data, such as age or occupation, e.g. both students; city; overlapping node affiliation(s); similar comments or queries, based on semantic analysis. Data from exceptional tags augments or adjusts results from the tag strength profile.

hybrid human-machine learning—system that integrates human input with artificial intelligence to enhance machine learning and capacity to deliver useful recommendations (prompts) and to evolve.

icon, badge—represents a keyword tag that can be attached to any content ID, user ID, action ID, organization ID, project ID, node ID to classify and, or award points to that ID. Keyword tags and other tags are represented by icons, badges to motivate human content tagging for keyword classification of content, and content rating such that the human-facing Graphical User Interface (GUI) crowdsources human users to rate, classify, and reward content and other contributions to the system. The term icon is used to denote a frontend visual, symbolic representation of a keyword tag, or other tag, such as a timestamp or geo-location tag, or user avatar. Each icon also serves as a node for all IDs containing that keyword and serves as a portal to all IDs with that tag in the system. The icon, a graphic symbol, facilitates crowdsourcing human pattern recognition for keyword tagging, rating and rewarding content by attaching badges to that content. Icons, badges also serve as lego blocks for human users to assemble into templates, game boards, and other customized graphical user interfaces for browsing, learning, navigation, and group collaboration—frameworks for curriculum, games, or other types of user interfaces to organize content. The term badge denotes use of an icon to award points. Icons, badges serve three additional functions. First, the act of awarding badges informs the recommender system about the preferences of that human user, since those tags, badge awards are recorded in the profile ID of both the award-giver and the award-recipient. Second, in a preferred embodiment badges are primarily awarded by human users because the act of awarding badges filters out external bot hackers as captcha systems block malicious agents, requiring the user to verify being human by performing tasks that a bot cannot perform. Third, each user receives points for tagging, rating, commenting, sharing, with points both to the content item tagged, and to the score of its content contributor. New icons can be added as needed.

ID—refers to a machine-readable identifier attached to every entity and action in the system, including human user profile IDs, content item IDs, project IDs, action record IDs, node IDs, or any other registered entities or actions. IDs are machine-readable for processing by the backend Intelligent Integrating System (IIS). Each ID contains two components, its registration data, or signature, composed of tags attached by the user who registered the ID, whether that ID is a human user ID, content ID, node ID, or another ID. Each ID also contains tracking data, its footprint, composed of tags added by both human users and the automated system whenever that ID acts, or is acted upon, in the system. Tags comprising the footprint can include keywords, timestamps, geo-locations, node tags, tags from pre-tagged templates or frameworks, and records of user actions or content usage, and other tags. The user's profile ID (signature and footprint) specifies how the system will receive content from, and deliver content to, that user. Blockchain can be used for the management of digital identities (IDs).

Intelligent Integrating System (IIS)—uses both human input and artificial intelligence to classify and link IDs based on their tags, which can include keywords, timestamps, geo-locations, and other attributes. The ISS organizes and manages content, including assembling clusters of related IDs (machine-defined), nodes (human user-defined) task requests, and other input IDs. By leveraging the pattern recognition capabilities of human users, and the computational power of machine learning, the IIS supports human registration and management of nodes, enabling the system to compute and compare related tag strength profiles to generate personalized recommendations. The IIS continuously evolves, improving its effectiveness at matching IDs to recommend to human users content, resources, and connections across the system.

node—Nodes serve complementary functions for the human-facing interface and the backend Intelligent Integrating System (IIS). Human users register all nodes, except keyword nodes, such that human users co-define the Graphical User Interface (GUI). Nodes can be registered by human user(s) to keep track of their own content or for larger collaborative missions. Each registered node also provides connectivity data to the Intelligent Integrating System (IIS). Each human user can register one or more nodes to serve his/her own user objectives, or group objectives in accordance with system guidelines. Each human user-defined node is a means to harness human pattern recognition to support machine learning such that nodes support machine clustering of IDs and networks of metadata spanning user IDs, content item IDs, and other IDs to create a rich web of associations to inform the recommender system. Each node can have sub-nodes or be connected to other related nodes, allowing users a rich browsing experience through which they can discover other users and related content of interest. Nodes, initiated by human user registrars, serve as collectors of user IDs, project IDs, organization IDs, resource IDs, and keyword topic IDs, or other IDs in this hybrid human-A.I. system where human users, by registering nodes, can identify, attract, and group complementary IDs and their tags. One exception to human registration of nodes: each keyword icon is auto-registered as a user-interfacing node for all IDs containing that keyword tag, thus serving as a portal to all IDs with that tag in the system. Human user registered nodes are complemented by machine-defined clusters.

Proof of Work (PoW)—acknowledges use of this term in bitcoin, blockchain, and cryptocurrency to prevent bad actors from overtaking the network. As used here, this term also excludes bad actors through peer review, scorekeeping, tagging, and verification of work performed online, or offline and reported online.

recommender module—provides customized prompts (recommendations) to users based on data from the connectivity module, including tag strength profiles, connectivity scores and tag associations of relevant content IDs, resource IDs, action IDs, project IDs, and other IDs. The recommender module integrates human inputs and machine learning algorithms, and analyzes user profiles, interaction patterns, and node affiliations to provide recommendations.

Scorekeeping—tally points awarded to each ID such that when a user, having consumed a content item, awards points to that content item ID, the system automatically awards points to at least one of the user ID of the content contributor, user ID of the current content rater, and to other user IDs that have commented, peer reviewed, rated or shared that content.

rag—descriptor attached to a machine-readable identifier (ID), representing a keyword, timestamp, geo-location, or other data, converted into machine-readable metadata. The system of this invention is managed by tags, which are used to classify all information defining an ID, whether a user ID, content ID, task ID, process ID, record ID or other ID. Keywords serve as main tags, represented as visual icons, and also as nodes for all IDs with that keyword tag.

tag strength profile—The tag strength profile is generated by scanning all tags in an ID, tallying the occurrences, ordering the tags by their frequency, and comparing the tag strength profile of the user ID with the tag strength profiles of potential IDs to be recommended in order to deliver customized recommendations. A tag in an ID is weak if it only occurs once in an ID, progressively stronger each time a new encounter with that tag is recorded in that ID, e.g. a researcher on climate change will encounter many content items, people, projects, universities, conferences, and so on, all IDs with climate change tags, each of which is mirrored in that user ID, which has recorded and timestamped each encounter with the climate change tag such that the climate change tag may appear many times in that user's ID, linking that user to a range of other IDs with that tag, increasing the strength of that tag in that user ID.

template—enables structuring content, such that users can contribute content that is preformatted and pre-structured with keyword tags, which partially classify that content in order to facilitate discovery and comparison with content of other contributors. Templates are provided by the Intelligent Integrating System (IIS) or developed by other users to facilitate content uploading, tagging, comparing with other related content, enabling discrete responders to input independent interpretations of data, weightings of alternatives, assessments, and other views, unconstrained by pressure for consensus from the group. Query structuring may be automated or may involve human users. In either case, iterative queries produce responses that are tagged, shown on a concept map or geographic map as needed, associated with the evolving profile of the contributor's user ID and integrated into the database of the Intelligent Integrating System.

timestamp—Timestamp tags are the most common tags in the system, since each act of tagging, uploading content, commenting, rating, and every other action, is timestamped. Timestamps enable blockchain or other tracking and are one criterion to determine obsolescence and removal of content from the system, though removal is not a simple timestamp expiration, since some content items remain relevant for a long time, or eternally, and some items that do not receive present attention may anticipate future needs.

timestamped obsolescence—Although timestamps enable removal of some IDs based on time stamped obsolescence, for many IDs a more nuanced method is required, combining timestamping and scorekeeping. Timestamps enable tracking critical path timelines, recording benchmarks achieved, and updating project status with Proof of Work (PoW) verification. The system includes means for tracking user engagement instances and duration on a timeline, calculating a current relevancy score for all content based on user visits and engagements with other users and content, or other resources in the system, enabling recommendations to be made. The system performs periodically an automated calculation of relevance and use of each item of information in the system, specifying whether, and at what rate, determined by use, or exceptional tags or designated long term value that is not time or use dependent, items in the system are held static, upgrade or degrade and are removed from the system. Since amount of current use is not an adequate determinant of future relevance, links from a content item to other content items that continue to be used may be the best available current method for determining potential future relevance of a content item, i.e. the accepted view on a topic will be used, whereas a not-yet-accepted view on that topic may not be used but will be linked to the currently accepted view, e.g., bosons, hypothesized in the 1920s, but not proven until 2012—a debated hypothesis is retained. Conflicting views can be used to teach critical thinking, countering current polarization that labels opposed views as “misinformation” to be censored and removed, allowing students to see only information designated by authorities as “correct.”

user registrar—Each human user first registers himself to join, which gives him an ID. Then he can register and upload a content item, which will also have an ID, tag and register content and other items, and perform other actions that complement automated tagging by the machine learning system to generate and update IDs, including user profile IDs, content item IDs, project IDs, action record IDs, procedure IDs, node IDs, timestamp tags, geo-location tags, and any other ID or tag registered in the system. For example, a user registrar can create a node, such as a user group. As in nature, redundancy is a strength: a user who creates a node for Bay Area hikers does not preclude another user creating a node with that mission if different names distinguish the two nodes.

### BRIEF DESCRIPTION OF THE DRAWINGS

FIG. 1a shows structural coupling: user-facing front end linked to machine-facing back end via machine-readable meta-tags.

FIG. 1b shows structural coupling: user-facing front end linked to machine-facing back end via IDs and their tag descriptors.

FIG. 1c shows structural coupling: user-facing front end linked to machine-facing back end via tags, assembled to define IDs (machine-readable identifiers), further organized by human users into nodes.

FIG. 2 shows a hybrid human-AI recommender system where tag strength profiles inform connectivity scoring to customize recommendations to user IDs.

FIG. 3 shows the tech stack from a Graphical User Interface (GUI) guiding human users to Embedded Continual Assessment (ECA) guiding machine reinforcement learning.

FIG. 4a-4i show how icons serve as frontend graphical user interface (GUI) lego blocks to crowdsource human users for machine learning from the tasks human users choose to perform, without a central controller or task requester assigning tasks to an anonymous crowd.

FIG. 4a shows registration of class nodes in a learning environment.

FIG. 4b shows a menu of icons used for keyword tagging and as badges to award points to outstanding content.

FIG. 4c shows a sample mobile user interface with icons for tagging, classifying, and rating content.

FIG. 4d shows one login embodiment where users can earn points, rewards, and contributor tokens translatable to fiat currency.

FIG. 4e diagrams show a cross-disciplinary node (POW! Media and sub-sub-nodes.

FIG. 4f uses icons to frame basic who, what, where, when, how? Questions for a keyword node and project node.

FIG. 4g shows a snapshot of an evolving annotation network for an Alice in Cinderland sci fi media project node.

FIG. 4h shows three steps in a project-based learning sequence: Basics, Questions, Impact, emphasizing the role of human designers assembling their own user interfaces.

FIG. 4i shows how the same icon lego blocks can be assembled into a labyrinth game board user interface, one of many embodiments not restricting the scope of this invention.

FIG. 5 shows user steps and system functionality for the content management embodiment.

FIG. 6a-6f show functionality of an embodiment for online content annotation.

FIG. 6a diagrams a user journey in a hybrid human-A.I. system to annotate online recordings, using icons for navigation.

FIG. 6b shows a customized word cloud generated from a user's unique click profile as the user watches an annotated recording, clicking on content of interest linked to keywords.

FIG. 6c shows how, based on each user's unique click profile, the system recommends stories, served via web or mobile app.

FIG. 6d shows a sample navigation page for a node to annotate a Food Security online forum, with sub-node keywords as surrounding icons.

FIG. 6e shows a user journey tagging, rating, and sharing content in an annotation embodiment.

FIG. 6f diagrams three calls to action after a user experiences online content.

FIG. 7a diagrams a mobile, web embodiment for tagging and sharing content.

FIG. 7b diagrams a mobile, web embodiment for a requester-responder transaction network.

FIG. 8a shows the TRACE cognitive knowledge processor flow diagram and impact tracker.

FIG. 8b shows the TRACE model applied in a Query-Responder Network with Embedded Continual Assessment (ECA).

FIG. 8c shows the TRACE model used to manage a crowdsourced innovation challenge or competition network.

FIG. 9 diagrams system components and architecture for a requester-responder transaction network.

FIG. 10 shows a flow diagram for a multi-nodal content management system.

FIG. 11 shows a flow diagram for a multi-nodal query response system.

FIG. 12 shows a hybrid A.I. tech stack, online markets, game stack, social networks, and the library stack, with scorekeeping operating to track exchanges, rewards and impact.

FIG. 13 shows how diverse users and devices are served from the cloud.

FIG. 14 shows the tech stack, from the Graphical User Interface to crowdsource human users to the machine and the cloud.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. The present invention, and some of its advantages, have been described in detail for some embodiments. It should also be understood that various changes, substitutions and alterations can be made herein without departing from the spirit and scope of the invention as defined by the appended claims. An embodiment of the invention may achieve multiple objectives, but not every embodiment falling within the scope of the attached claims will achieve every objective.

The human-A.I. Embedded Continual Assessment (ECA) system of the subject invention is a technical advancement in five ways. First, the subject invention is a SaaS (Software as a System) social network in which human users, pursuing their individual human priorities for search, discovery, and record-keeping for their own work, make autonomous decisions and perform actions as users within a system framework where each unique human user has “collaborative autonomy” and, as such, is a core contributor to machine learning and system functioning. The recommender system of the subject invention supports crowdsourcing such that users operate with collaborative autonomy, simultaneously adding and modifying annotations, with changes tracked and attributed to each user. The collaborative intelligence of many annotators, unknown to each other, with no consensus required, makes annotating online recordings like writing articles for Wikipedia.

Second, the subject invention harnesses diverse graphical user interfaces (GUIs) and icons, badges to structure human crowdsourcing for machine learning, relying on three elements to mediate bidirectional interactions from its frontend GUI and human users to backend machine processing, and vice versa, such that iterative cycles of Embedded Continual Assessment (ECA) underpin human-A.I. collaborative intelligence. These three bidirectional elements are tags, IDs (machine readable identifiers comprised of tags), and nodes registered by human users (machine readable identifiers comprised of IDs, which are comprised of tags). Structural coupling of human prompts to machine learning is mediated by graphical user interface (GUI) design such that the machine component of the subject invention, by tracking and recording human actions, crowdsources its own training and monitoring.

Third, to overcome limitations of conventional practice, such as failures in pre-training Large Language Models (LLMs), and then releasing them to perform independently, the subject invention implements human training-in-action such that the machine learns through performance, enabled by continual, ongoing feedback from human users via Embedded Continual Assessment (ECA) feedback loops, an extension of RLHF (Reinforcement Learning with Human Feedback) and RAG (Retrieval-Augmented Generation).

Fourth, scorekeeping enables impact tracking, offers game-like incentives, provides transaction exchange functionality, and underpins crowdsourced human peer review, which guides machine learning. The machine component of the subject invention, by tracking every human action, crowdsources its own training and monitoring. Tasks are rewarded with points, as with airline miles, and the number of points received translates into tokens. Human peer reviewers perform scorekeeping by awarding icons, badges, thus conferring points to content. Peer reviewers also receive points for their service, points not only for contributing content but also for commenting, evaluating, sharing, and using, or other valued tasks that earn points, tokens or other rewards. The system can award points to human users for both on-line and off-line contributions with validated reports and, or peer review—Proof of Work (PoW) of both online and off-line contributions. All scorekeeping, impact tracking, capacity to earn tokens or rewards in the system is based on peer review rating, comments, and badge points in diverse keyword categories. Points, which can be translated to tokens or other contributor remuneration, enable scorekeeping and translation of tokenization to Contributor Income when defined conditions are met.

Fifth, whereas the term crowdsourcing typically connotes a central human task requester, broadcasting a single task request to a homogeneous crowd of anonymous human micro-task performers, the subject invention redefines crowdsourcing, not as initiated from central command-and-control, but as driven by distributed human users delivering, without a central task request, what the machine learning system needs to learn about its human users. Each distributed, unique, non-anonymous human user is an autonomous agent, enabled by the system to pursue unique learning and discovery objectives, such that human users are crowdsourced to co-design the system. Human users prompt the machine in unique ways, and the machine in turn prompts (delivers recommendations to) its human users via ongoing iterative feedback cycles of human-A.I. co-prompting that evolves toward increased human-A.I. collaborative intelligence.

Finally, the subject invention moves beyond the top-down control assumption that bigger is better, whether bigger LLMs or bigger datasets of human buyers for collaborative filtering. Huge LLMs can be more cumbersome, expensive, and subject to slower evolution, whereas smaller models can mimic natural evolution, rapidly trying many experiments, failing faster, but also adapting faster. Commercial applications of collaborative filtering in recommender systems typically have huge datasets of buyers but shallow knowledge, knowing only what customers bought, not why each customer made each decision or what each human user is trying to do. The subject invention follows user paths over time, developing deeper knowledge of user motivations to inform recommendations, which are co-developed with each user, much as a good advisor listens to a client, enabling that client to make better decisions by asking good questions that support the client's own decision-making.

In one embodiment, the system comprises a hybrid human-A.I. recommender system designed to crowdsource human users to train the machine learning system, wherein a Graphical User Interface (GUI) guides human users and Embedded Continual Assessment (ECA) guides machine reinforcement learning and enables scorekeeping and timestamping to determine the lifecycle of items in the system, ensuring that content is upgraded or removed based on use and long-term value. Encoded instructions configure the system to populate a graphical user interface (GUI) with a menu of content and other customized recommendations for the user profile ID, based on that user's tag strength profile and other markers. In another embodiment, the system populates the GUI with a format to rate content after consumption, including a menu of icons and badges for awarding points to content, commenting, keyword tagging, rating, and voting. The system tallies points awarded to each ID such that when a user, having consumed a content item, awards points to that content item ID, the system automatically awards points to the user ID of the content contributor, to the user ID of the current content rater, and to other user IDs that have commented, peer reviewed, rated or shared that content. In a further embodiment, the system timestamps when a user ID uploads original content, allocates to that user ID initial points on upload, and additional points each time the content ID is rated, shared, tagged, or receives natural language comments or peer review. Points earned for any contribution are augmented based on how much that contribution is used, shared, positively rated and peer reviewed, such that cascading effects from downstream use augment the point score of that contribution and its contributor, as when a professor uses content in a course, or another user cites the content.

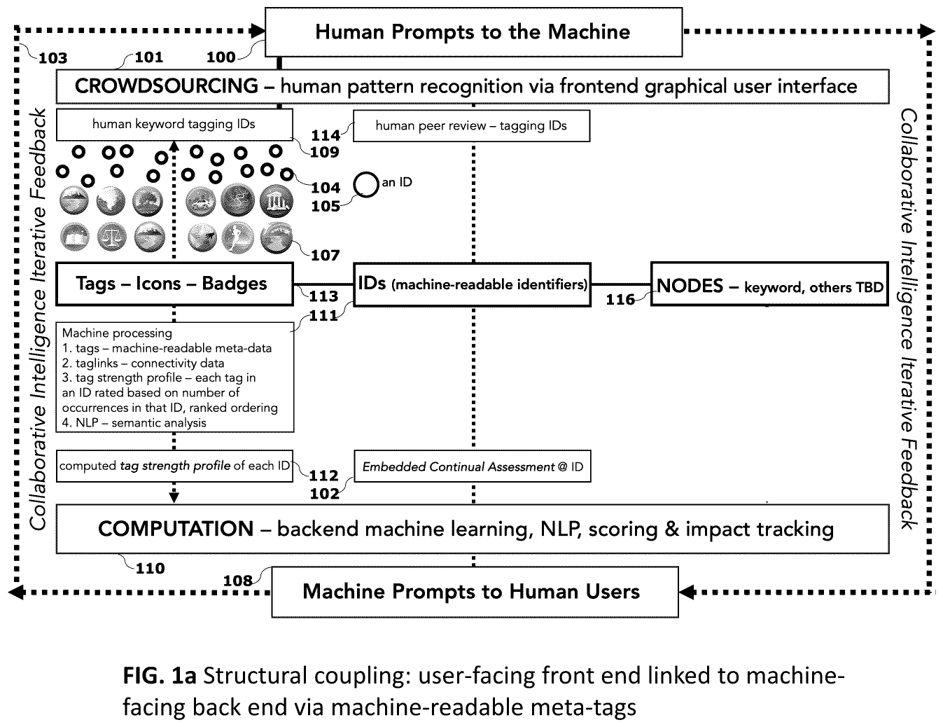

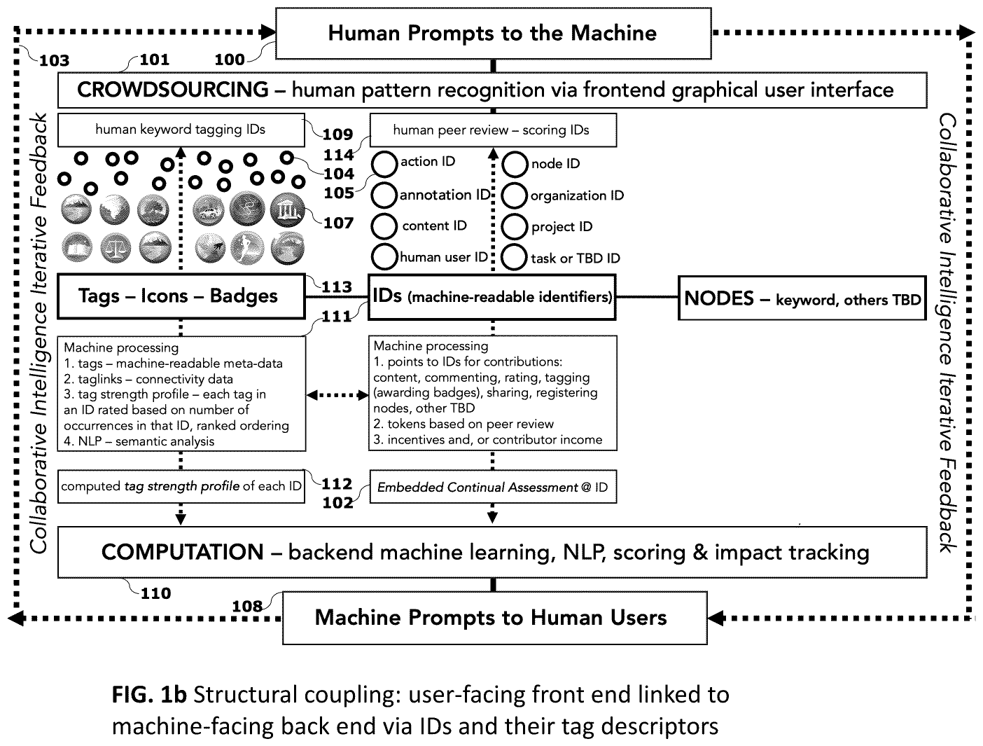

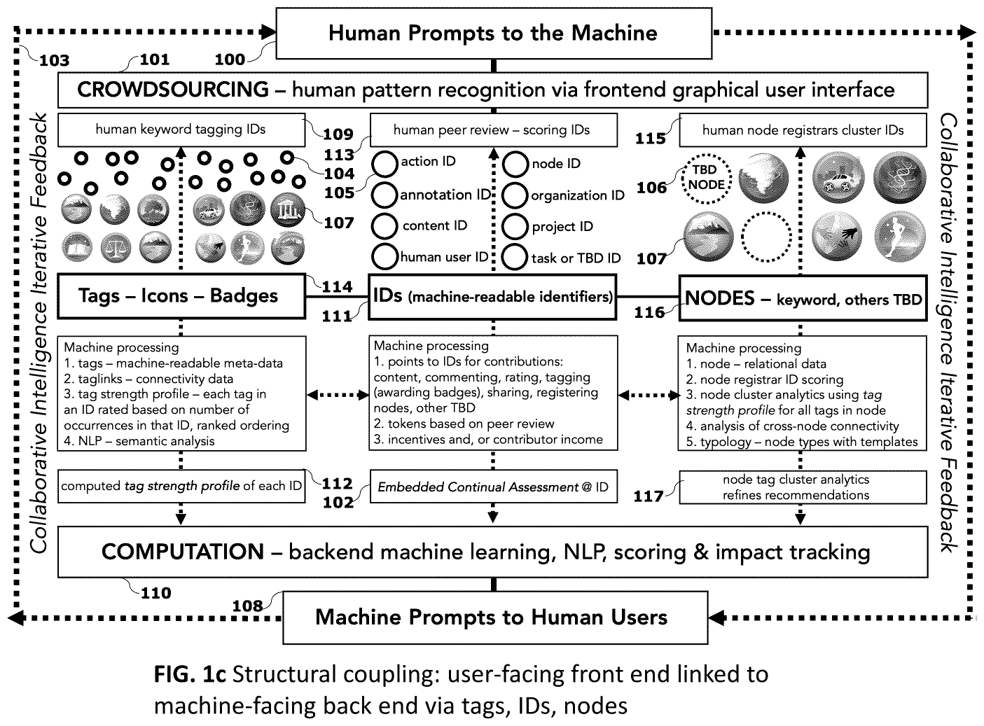

FIGS. 1a, 1b, and 1c are exemplary system diagrams in accordance with an aspect of the invention. The figures introduce three elements of human-machine structural coupling that underpin human-A.I. collaborative intelligence. These introductory figures are followed by figures describing the system structure and how the frontend graphical user interface enables human crowd-sourcing for machine learning. The hybrid human-A.I. Intelligent Integrating System (IIS) of the subject invention, as detailed in the claims, integrates a processor and a non-transitory storage element containing encoded instructions that configure the system to perform key functions. These functions include receiving tags attached to diverse profile identifiers (IDs), converting these tags into machine-readable metadata, computing the strength of every tag attached to a given ID based on the number of occurrences of each tag in that ID to produce a tag strength profile for that ID; and matching each user ID with IDs of at least one of a user ID, action ID, content item ID, keyword ID, node ID, procedure ID, resource ID, based on comparing the tag strength profiles of their IDs in order to provide customized recommendations, thereby leveraging the collaborative autonomy of human users and the processing power of the machine, advancing the field of machine learning and recommender systems through dynamic, evolving hybrid human-A.I. collaborative intelligence.

FIG. 1a diagrams the structural coupling of human prompts to the machine 100 in a system where crowdsourcing 101 harnesses diverse graphical user interfaces (GUIs) to tap the intrinsic motivation and pattern recognition of its human users such that the system evolves without requiring top-down control or consensus. Each human user “does his/her own thing,” navigates where s/he wants, selects options, and organizes knowledge to support his/her own domain of action or research.

FIG. 1a shows the first element, tags 104, as descriptors, labeling every attribute in the system, from keyword tags 107 to timestamps to geo-locations, tags of all types 104 attached to, and defining, every ID 105 in the system, including timestamp and geo-location tags 104 to further describe that ID. Tags have a frontend face, as in the case of keyword tags, which can be represented in the graphical user interface 101 as icons, badges 107, engaging human visual pattern recognition. All tags are converted by the system into machine-readable meta-data used by the backend machine learning system 110 to compute tag strength profiles 112 to analyze connectivity. Most used keyword tags are symbolized on the frontend with visual icons 107, which human users award as “badges” to confer points in that tag keyword category to valued content IDs, action IDs, project IDs, or other IDs 113. Human peer review serves to tag and classify content and to score content and award points 114, as shown in FIG. 1b.

FIG. 1b shows the second element, IDs 105, which are machine readable identifiers comprised of tags. All IDs in the system are uniquely describable by their machine-readable identifiers 111, whether human user IDs, content item IDs, action record IDs, project IDs, node IDs, or any other item ID or action ID in the system. IDs also have a front end and back end. A user ID generally has a public profile, visible to all other users. Depending on the embodiment, that user ID may include a picture or avatar icon. Content items, projects, and other IDs, generally have public profiles with ways to gain a quick overview, such as an abstract (if content), bio (if user), summary (if project). Human user peer review not only crowdsources keyword tagging 114 but also serves the double function of classifying content by keywords and rating that content awarding badges, which not only give points to IDs 105, both in the category of the keyword, and generally. FIG. 1b shows a machine-readable identifier (ID) for every user, content item, resource, action, procedure, project or other entity or action in the system. Each tag in an ID is automatically connected to all other IDs with identical tags (shared attributes). Any tag contained in an ID links that ID to all other IDs with that tag, making all IDs in the system potentially connectible via their tags.

FIG. 1b further shows a recommender system to deliver specialized recommendations to each user based on selecting a particular tag, or subset of tags within that user's ID, computing a score for some subset, or several subsets, of tags in that user's ID, and summing a subset tag profile for that ID into a partial connectivity score for some aspect(s) of that ID to inform specialized recommendations. In addition, the system has multiple ways to compute a relational connectivity score. In one embodiment, the system provides the user with a dial, much as some generative AI apps permit the user to vary strong or weak, enabling the user to tune up for more identical matches and down for broader search. The system can also augment recommendations based upon connectivity scores using additional parameters, such as user queries, user performance history or level in the system, and user behavior. One embodiment can incorporate user behavior patterns, such as duration and intensity of interactions with tagged content. Tags associated with prolonged engagement or repeated interactions are weighted more heavily, reflecting their higher significance to the user. Integrating semantic analysis with behavioral data provides a more user-centric and nuanced calculation of connectivity scores, enabling the Recommender Module to generate personalized and contextually informed recommendations. In addition, to broaden the range of recommendations for each ID by using, not only identical tags, but also tags discovered through node affiliations of the user, or tags associated with another ID having, not a similar tag strength profile, but at least one strongly weighted tag that is identical to a strongly weighted tag in the user ID, thus potentially introducing the user to IDs not previously connected.

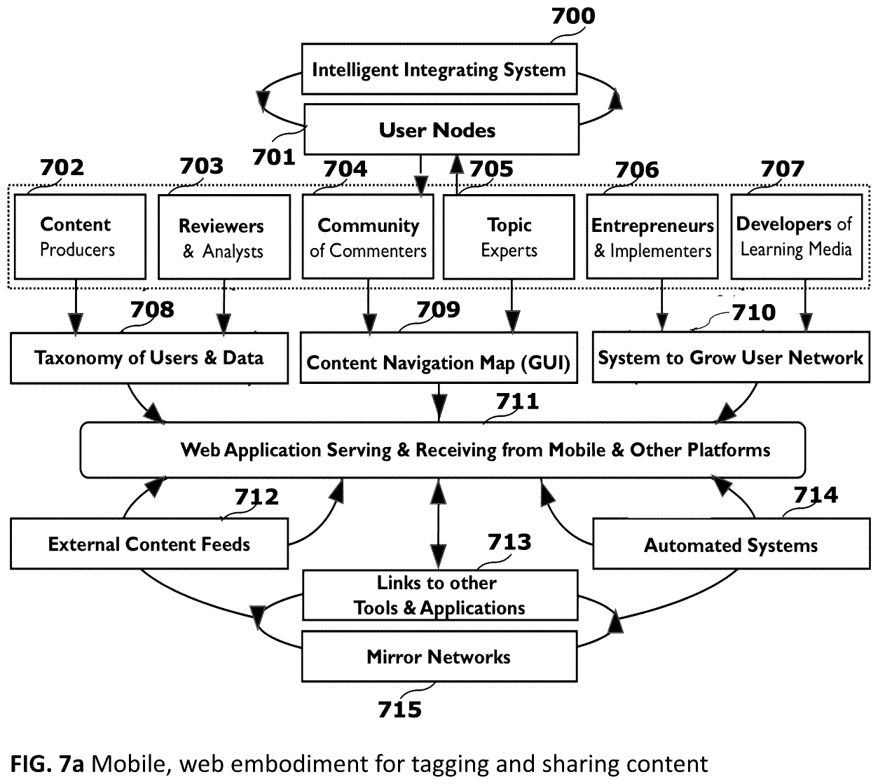

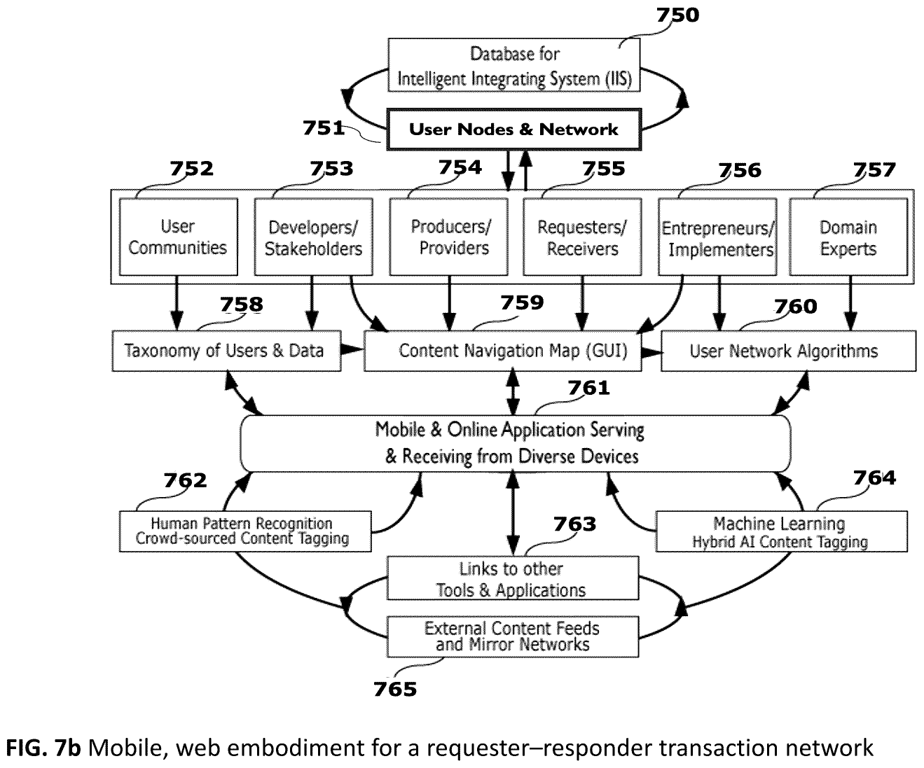

FIG. 1c shows the third key element, nodes 106. Each user ID can register a node ID to assemble other user IDs, action IDs, content item IDs, keyword IDs, node IDs, procedure IDs, resource IDs for task performance, content collection, search, discovery, sharing, and record-keeping. A personal node can address a user's personal work or hobbies, from book authorship to hiking, while a group node such as a class or organization node, supports collaboration. This feature enhances the system's flexibility and utility, enabling users to manage and navigate their information and connections. Keyword nodes 107 are defined by the keywords they represent, and these nodes are automatically registered in the system. Each keyword node is symbolized by the same icon as its tag and may contain sub-nodes with more specific sub-topic focus or virtual labs for individuals or groups doing work relevant to that keyword tag. Other To Be Defined (TBD) nodes can be originated, named and registered by human users as a way to organize information to serve their objectives. These to-be-defined nodes, shown in FIG. 1c with dotted line 106, enable human users to co-define the frontend human user experience. They also provide additional relational data for the backend machine to refine recommendations. “You-can-register-a-node” functionality taps human motivation and pattern recognition as the human registrar of the node and, or human users of the node, engages human users to organize IDs into nodes 106 as defined either by the human user registrar, or jointly by the collective of human users who start or join the node. A user can register a node to serve that user's personal agenda, such as a topic-focused discussion group, event series, competition, media production, and so on. The node can start small and grow. A project may first be registered as a private ID 105 where an author can assemble resources for writing a book. When an ID grows to involve other IDs, it becomes a node, with one or more virtual labs for IDs 106. A project initiated by one user as an ID may become a collaboration, such as a film production, or startup company, or organization containing more than one ID, which is then registered and given a name as a node 106. Nodes augment the structural coupling of the frontend human users with the backend machine, capturing connectivity data to augment ID tag strength profiles with node connectivity weightings to inform recommendations 117. Finally, in another embodiment, a registered node ID can contain one or more virtual labs, designated as public, private, or restricted. Users can start new labs as needed, with appropriate access restrictions, and move their content between labs. FIG. 7b highlights the IIS's ability to track and record usage by tagging items by content, time, and place, including human user profile ID tags, geographic-locator tags, timestamp tags, and tags specifying the user's role. This enables in-person, online, and asynchronous exchanges and transactions. Nodes inform machine clustering of IDs and tags and also inform the backend recommender system about user preferences.

FIG. 1c further shows that the machine learning system relies on three elements to mediate bidirectional interactions from frontend human users to backend machine processing, and vice versa, such that iterative cycles of Embedded Continual Assessment (ECA) 102 underpin human-A.I. collaborative intelligence 103. These three bidirectional elements are tags 104, IDs (machine readable identifiers 111 comprised of tags) 105, and nodes (machine readable identifiers comprised of IDs, which are comprised of tags) 116. The subject invention crowdsources each human user's unique opinions, capacity for pattern recognition and intrinsic motivation to rate, tag, and award points to content IDs and other IDs, which are peer reviewed as contributions 105 and also enable machine learning, in turn enabling the machine to customize better recommendations for its human users 108. Human users prompt the machine in unique ways 100, and the machine in turn prompts (delivers recommendations to) its human users 108, such that ongoing iterative feedback cycles of human-A.I. prompting evolve toward increased human-A.I. collaborative intelligence 103. Human users are crowdsourced to attach general tags 104 and keyword tags 107 to IDs, such that each unique human user, via tagging 109, classifies content in the system, also providing profile information about that user, which in turn enables the machine to prompt each human user with recommendations customized for that user 108.

FIG. 1c shows how human node registration 115 enables the machine to cluster IDs and identify complementarities across diverse IDs in a given node 116 such that machine analytics of node tags, beyond matching tag strength profiles for similarity, can refine recommendations based upon complementarities 117. A human user, by attaching keyword(s) to a content ID 113, is also awarding badges 114, classifying that content ID with that keyword 107 and also awarding points to that content ID, its human contributor ID, and any other involved IDs 113. What a user experiences as an autonomous voter, “awarding badges” (icons, tags) that confer points to preferred content serves the backend system as crowd-sourced content rating and tagging, but the user experience does not feel like “being crowdsourced” to tag content. Tags, icons, badges engage human user peer review of all content, whether generative A.I., human, or hybrid A.I., and all actions in the system. Human checking, verification of authenticity, and quality control enables contributions, both human and A.I., to be monitored for fake news, plagiarism and other anomalies attributed to human hackers, A.I. agents, or both. Tags, converted by the backend IIS into points awarded for contributions to a content ID, project ID, or other ID, also enable the IIS to compute and compare the evolving tag strength profile 112 of every ID in the system.

FIG. 1c further shows how a human user can register a node as a “virtual lab” for an ID collection to address that user's personal objectives or group objectives 117. All nodes serve their human users as “virtual labs” to aggregate diverse IDs, including other human user IDs, content IDs, project IDs, task IDs, and other IDs. Growth of the system occurs as users register nodes for their own organizing purposes 106, such that the system evolves bottom up. A human user can register a node as an organizing hub for his, her own work or hobby: local bird-watchers, hikers, investors. A human registrar may invite friends to join his node, or the node may be open and discoverable via its keywords, with the machine recommending the node to users based on their profiles and activity in the system. Human crowdsourcing underpins growth and evolving functionality of the system such that training-in-action feedback loops provide ongoing human peer review for all content, whether generated by humans, A.I., or hybrid entities or actions in the system. Continual feedback from human users, processed through Embedded Continual Assessment (ECA), supports machine learning.

FIG. 1c shows nodes, which can have sub-nodes (e.g. one sub-node for climate change is forests) and virtual labs that can be registered as public, private or restricted. Summarizing node and lab types: 1) Public Nodes—Film-makers can produce “living films” such that fiction stories, documentaries, or any other online media can be annotated, increasing its audience by making it more likely that the film can be used in teaching and also giving the film a long tail. Suppose that an admirer of Akira Kurosawa registers a Rashömon node, not with a mission to annotate that film, but honoring that film with the node's mission to explore many points of view on contentious topics, encouraging critical thinking. With permission, great historic films can also become annotation nodes. After release of Jurassic Park, enrollment in university paleontology programs skyrocketed; a Jurassic Park node could connect students entering this field. Many Steven Spielberg films have raised awareness, from The Color Purple and Amistad to Schindler's List and Minority Report. The production of Schindler's List inspired Spielberg to launch the Shoah Foundation, first to collect the stories of Holocaust survivors, and later expanded to collect stories from other discriminated groups, which inspired It's Our Story, collecting the stories of the disability community. Rocky movies ramped up the fitness trend. Al Gore's Inconvenient Truth raised climate change awareness. The China Syndrome increased public opposition to nuclear power. Health as a public keyword node includes sub-topics, such as Diet or Exercise, which can also be registered as nodes, either independent or as sub-nodes of Health. A user can select an online media recording from a collection, either fiction or non-fiction, set up an annotated recording node ID with the name/topic of the recording, such that other human users can join this annotation community, linking other content IDs or other IDs to this annotation node such that annotation crowdsources the input of many users and grows a community around a topic or mission. 2) Public-Private Nodes can serve many individuals and groups, e.g. a writer can register a public-private node with a private area as a personal sandbox to collect materials for writing a book, and a public area where periodic release of public articles and books occurs, with associated talks and discussions. Public-Private Nodes can also grow around specific communities sharing information, such as the BIPOC community, Equity=Democracy community, online privacy community, Parkinson's community, or a prison reform community where the public face is anonymous, providing general information to encourage users to join, with personal exchanges occurring in a private area. 3) Public-Restricted Nodes have diverse functions. An expert in disaster preparedness and response can register a public regional node, with public information, and a lab restricted to users living in a specified geographic region, perhaps open to experts in all locations, with multiple types of disaster sub-nodes for fires, power outages, heat emergencies, floods, storms, earthquakes specific to that region that can be rapidly activated in an emergency.

FIG. 1c shows that nodes can be diverse. A professor can register a restricted class node (open to students in his class only) to keep track of, and organize, assignments, content, guest speakers, lesson plans, projects, students, tests, and so on, followed by several other university professors registering their classes. Embedded Continual Assessment tracks total points earned by any ID in the system, with total points earned by a node ID, such as a class node ID, comprising all points to student IDs in the class node ID, such that the system can be used for student grading or class comparisons, employee performance review, and calculating contributor payments in points, tokens, rewards, or trading cards. For example, a student ID in a class is tracked as an individual ID to be used to grade individual student performance in order to award points or tokens. The system also tracks the performance of each node ID as a whole, such as a class ID or alliance network ID or project sub-node ID for a team of students or working group, summing the footprint component of all individual IDs to assess node ID, sub-node ID, and individual performance. Once there are many users, existing nodes in the real world may have mirror nodes in the system. For example, a university can register itself as a restricted node, open to those with university IDs, perhaps first using the functionality of this invention to facilitate faculty engaging in cross-university collaborative research, or faculty collaboration with external enterprises, or student internships. 4) Public-Restricted-Private Nodes can also serve diverse functions. Any node can have one or more private “virtual lab(s),” as where students in a class can collaborate on a group assignment, co-authors or editors can collaborate on a not-yet-published book project, innovators can collaborate on confidential IP, or users experiencing health symptoms from products, such as Monsanto's Roundup, can privately and anonymously share information such that the forty-four years required to organize the class action lawsuit against Monsanto for Roundup can be reduced, and other toxic, or otherwise faulty, products identified more rapidly. Because reporting harm or compliance failure, or other malpractice issues, can expose the reporter to retribution, such nodes can have a signature public face in order to be discoverable, but user IDs and their content, can remain private and anonymous. A collective of small farmers can register a node with public information available to anyone about seed patents and lawsuits against small farmers who produce their own seeds, with sub-nodes where membership is restricted geographically by legal jurisdiction to share information relevant to that jurisdiction, and private “labs” in each sub-node to share information and improve capacity to negotiate with seed monopolies. Public-Restricted-Private Nodes serve all instances where there could be retaliation against the organizers of an empowered collective to remove products like Roundup from the market faster, and to support leveraging Extractor Taxes against Bayer (Monsanto), and other corporate giants, who own 60% of seeds and sue farmers who produce their own seeds. The system of this invention can be used as a coalition-builder to support the formation of collectives and to link collectives with related missions or interests.

FIGS. 1a, 1b, and 1c together visualize three elements that underpin human-A.I. collaborative intelligence and co-prompting—humans prompting the A.I. and the A.I. in turn prompting its human users in continual, iterative feedback loops: 1) tags 104, 2) IDs (machine readable identifiers comprised of tags) 105, and 3) nodes (machine readable identifiers comprised of IDs, which are comprised of tags) 106, all Janus-like, two-faced elements with one face to the frontend, the visual, human-facing graphical user interface, which crowdsources human user pattern recognition 101 driving human-A.I. feedback loop iterations through which the machine learning system evolves, and another face to the backend, where tags and IDs containing tags, and nodes containing IDs, comprised of tags, are converted to machine-readable metadata by the A.I. backend Intelligent Integrating System, which computes, compares, and continually updates tag strength profiles 112 across all IDs in the system, whether human user IDs, content item IDs, action record IDs, project IDs, node IDs, or any other item ID or action ID in the system. The tag strength profile of an ID 112 is used to generate customized recommendations for that ID 108, augmented by analyzing natural language comments, node affiliation(s) and other data.

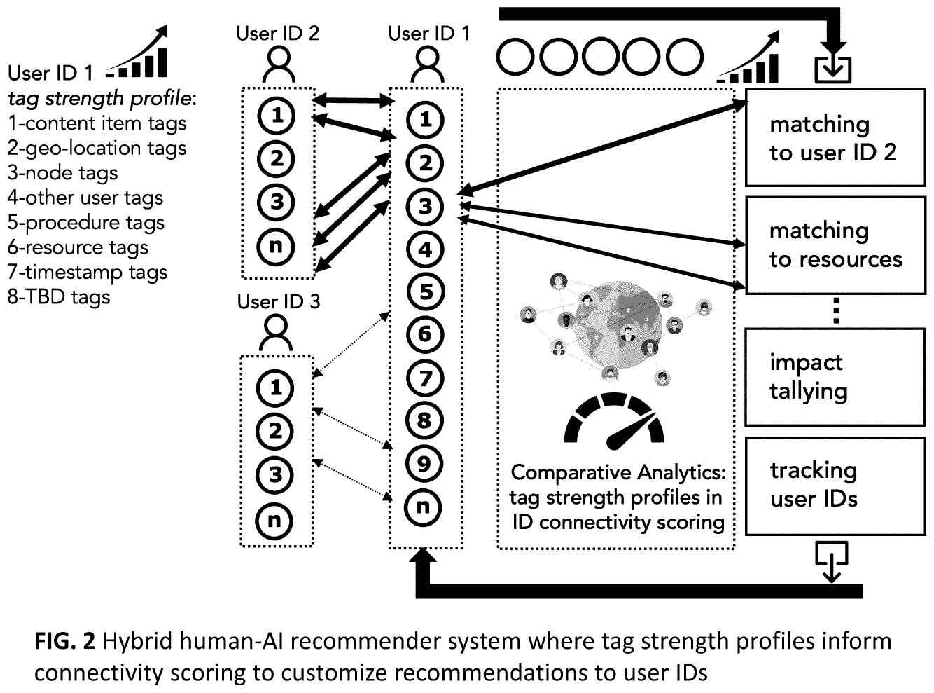

FIG. 2 illustrates an exemplary system diagram for a hybrid human-AI recommender system based on IDs, which are defined by tags. The user ID tag legend on the left lists tag types in the User 1 ID, which the Connectivity Module processes to create a metadata profile for User 1 ID, including content item tags (1), geo-location tags (2), node tags (3), other user tags (4), procedure tags (5), resource tags (6), timestamp tags (7), and to be determined (TBD) tags (8). The diagram shows that User 1 ID has a stronger connection to User 2 ID than to User 3 ID, visually represented by more and thicker lines connecting tags in User 1 ID and User 2 ID, weaker connection to User 3 ID, represented by thinner lines. As User 1 engages with the system, responding to prompts (recommendations), these actions attach new tags to User 1 ID for further tag mining by the Intelligent Integrating System (IIS), providing more data on which to base recommendations. The Recommender Module uses the tag strength profile of User 1, matched to similar tag strength profiles for other IDs to make recommendations.

In order to make customized recommendations, the IIS scans all tags in a given user's ID, computes the strength of each tag, scores those tags by weight based on the number of occurrences of that tag in a user's ID to create a tag strength profile for that user ID, which is then used to customize prompts (recommendations) for that user ID. The tag strength profile for any ID in the system is a list of tags in that ID, ranging from strongest (most occurrences) to weakest (fewest occurrences). An ID tag strength profile links that ID to a network of other IDs (users, content items, action records, projects, etc.) with similar tag strength profiles in ranked order of similarity such that the system can decide what recommendations would best suit both the user receiving recommendations and the IDs being recommended (people, content items etc.) based on priorities of all users. In addition, other data also complements the tag strength profile, such as criteria from exceptional tags, user behavior, natural language comments, peer review, queries and other input. In one embodiment, to score impact, computing the value and influence of user contributions, the system performs semantic analysis on natural language comments and scores based on ratings from other users. Profile tracking monitors ongoing interactions, dynamically updating user profiles to improve recommendations. Each user contributes to collective knowledge in the IIS ecosystem, enhancing overall accuracy and relevance of system recommendations. The diagram shows how each component of the system interacts with others, highlighting data flow from tag input to recommendation output.

The system can further customize recommendations by supplementing the tag strength profile with exceptional tags, which provide key ID profile data, such as age, occupation, location, and node affiliations, and noting similar or related comments or queries based on semantic analysis. A partial ID tag strength profile can be computed for an ID using specific tags, or subsets of tags within an ID. Partial tag strength profiles within an ID can be segmented in various ways to compute a score for some aspect of that ID, as when a user specifies that s/he wants only recommendations related to A.I. animation tools and projects. Recommendations to a user ID can be further refined with data such as geo-location, links to other users, natural language queries or comments, node affiliations, user interaction patterns, performance history, and timestamps as well as preferences of other user IDs with similar profiles and other similarity markers, as potential recommendations.

In alternative embodiments for generating tag strength profiles, the system may employ a weighted tagging approach where certain tags are assigned more significance based on predefined criteria or contextual relevance. For example, tags related to recent activities or frequently updated content can be given higher weights. Another embodiment entails user-specific customization where the system learns from individual user interactions to adjust the importance of certain tags dynamically. Additionally, machine learning algorithms can be employed to detect patterns and correlations among tags, refining tag strength profiles over time based on observed user behaviors and preferences. In another alternative embodiment, the system can integrate external data sources to enrich the tag strength computation, incorporating information such as social media activity, browsing history, or purchase patterns to provide a more comprehensive profile, further enhancing accuracy and relevancy of recommendations generated by the system.

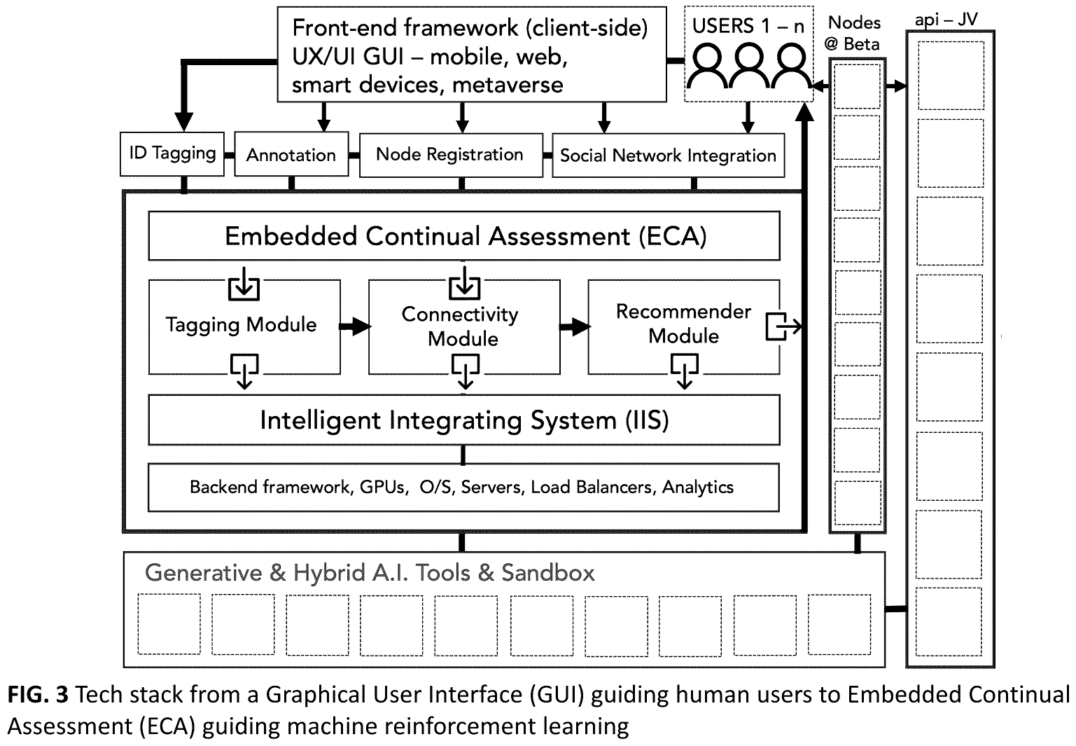

FIG. 3 is an exemplary system block diagram illustrating the tech stack in accordance with an aspect of the invention. At the top are front-end human-facing components. The UX/UI Graphical User Interface of the front-end framework (client-side) enables human users to perform tagging, annotation, node registration, peer review and rating, social network integration, and other tasks, through which human users train the machine learning system. Embedded Continual Assessment (ECA) extends Reinforcement Learning with Human Feedback (RLHF) by connecting human users and the machine into hybrid human-A.I. collaborative intelligence feedback loops with three modules that feed into the Intelligent Integrating System: the Tagging Module, the Connectivity Module, and the Recommender Module. All aspects of system performance are tracked and tallied by the Intelligent Integrating System (IIS), which starts by receiving tags associated with at least one of a user ID, action ID, content item ID, keyword ID, node ID, procedure ID, resource ID geo-location tag, and timestamp tag and converting these tags into machine-readable metadata. The Tagging Module assembles these metadata tags into IDs, each ID comprising a comprehensive, evolving set of metadata. This human-machine system is configured to link to, and collaborate with, external developers of generative and hybrid A.I. tools, using a sandbox for experimentation and private nodes for proprietary systems, with beta tests to integrate the functionality of each api (Application Programming Interface) and jv (joint venture). RLHF (Reinforcement Learning with Human Feedback) and Retrieval-Augmented Generation (RAG) are extended through the rapid, iterative feedback loops of Embedded Continual Assessment such that the machine-learning system continually updates each ID, improving its own performance. Generative A.I. content, human-generated content, and hybrid human and A. I.-generated content are subjected to crowdsourced human-A.I. assessment via peer review. Human user contributions, navigation and other choices inform system evolution.

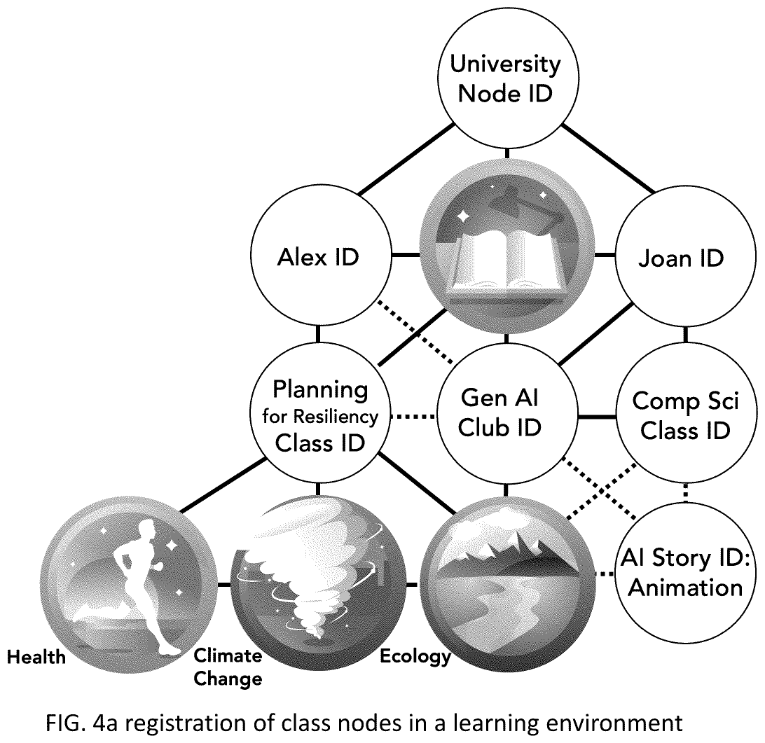

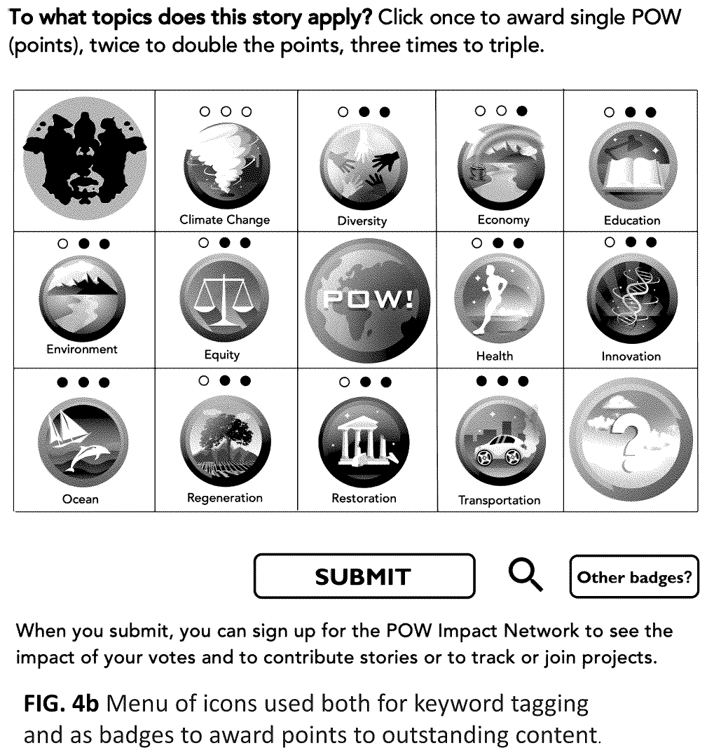

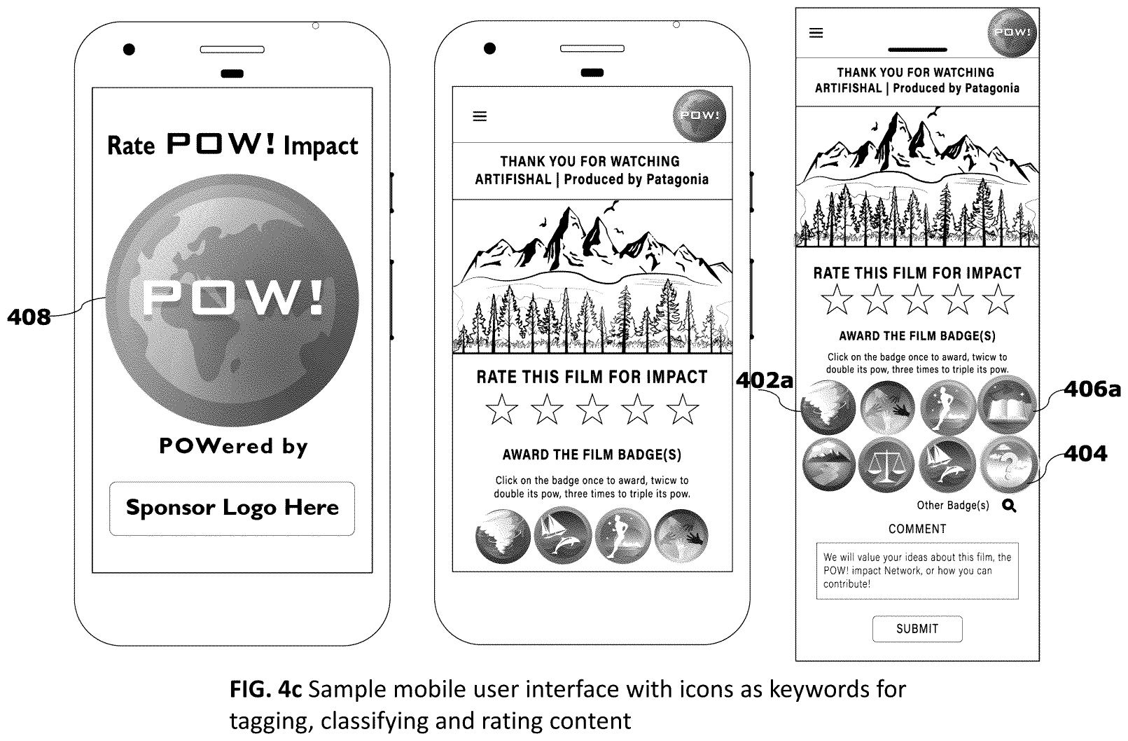

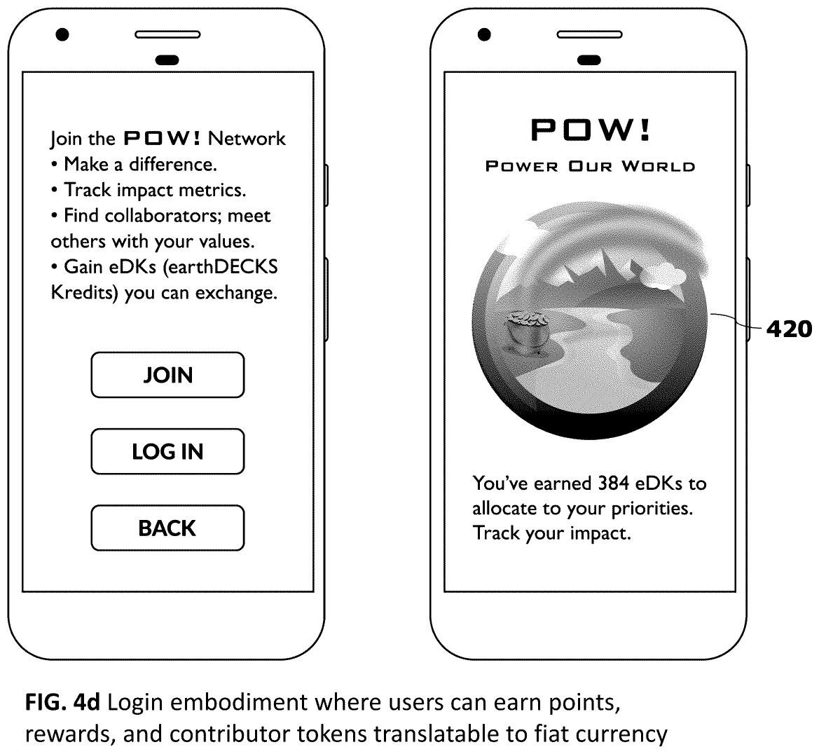

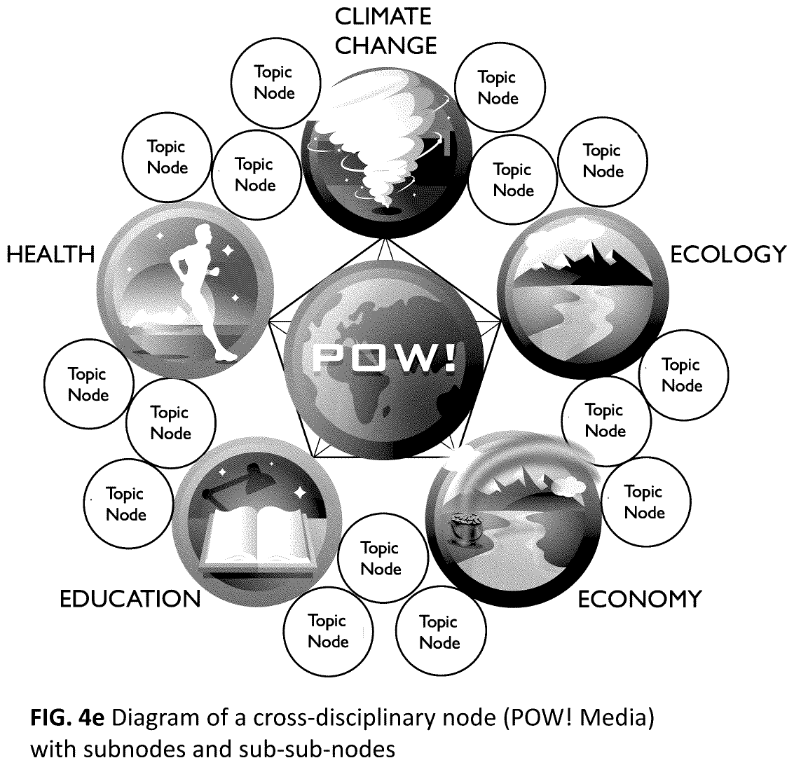

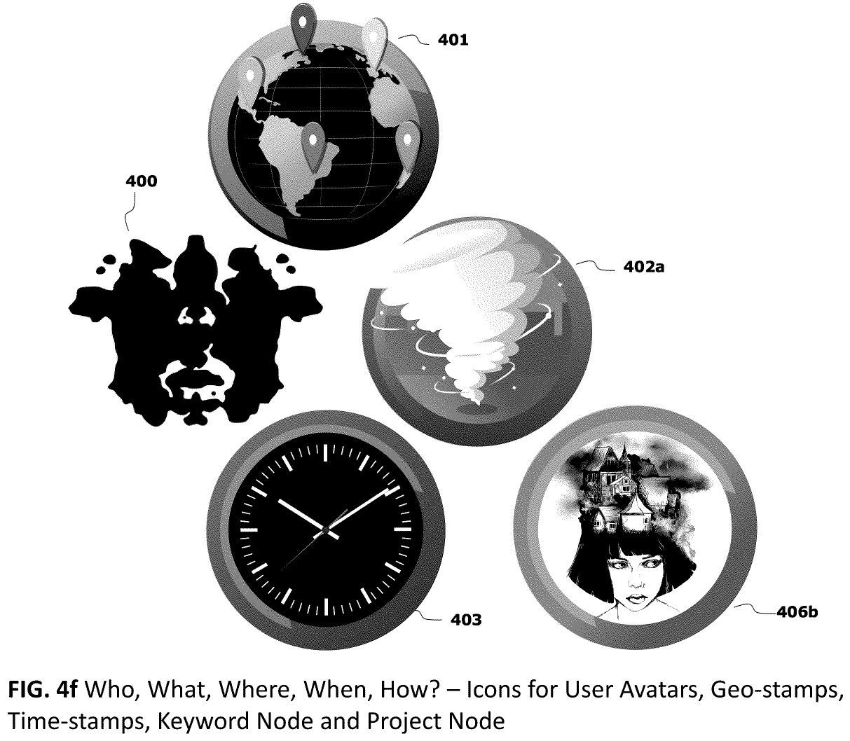

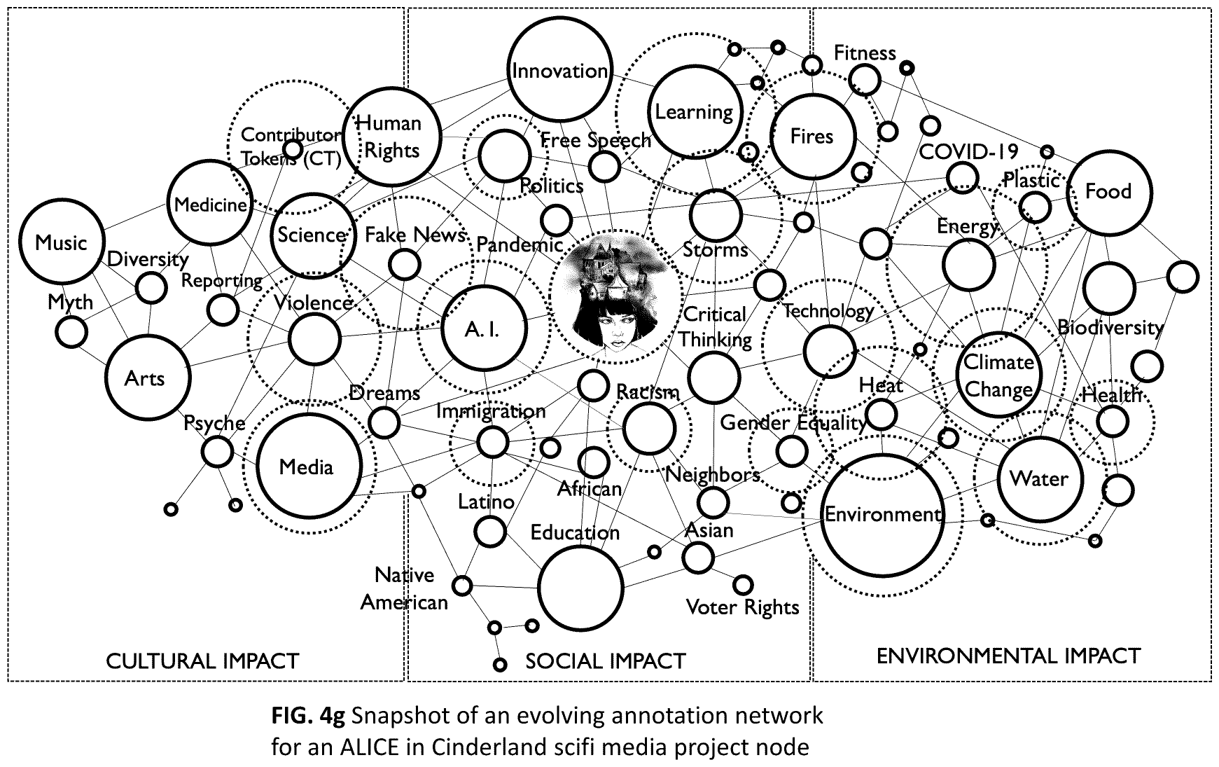

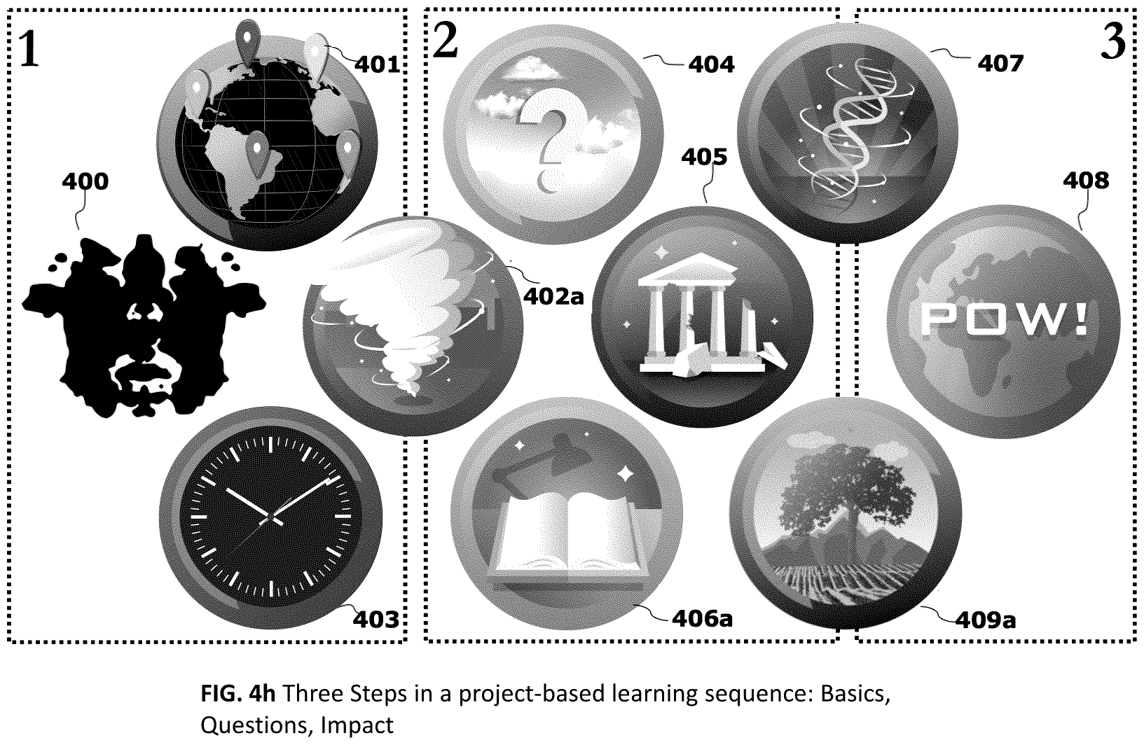

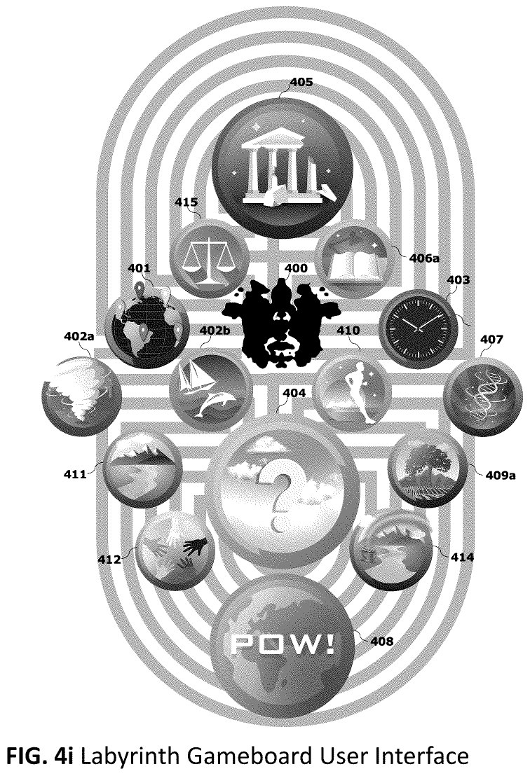

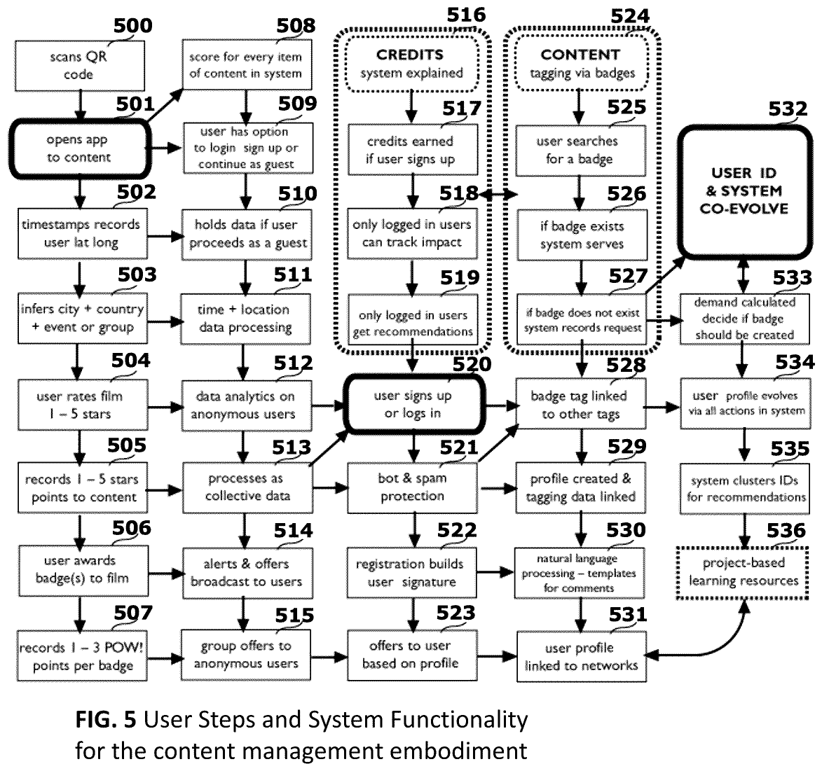

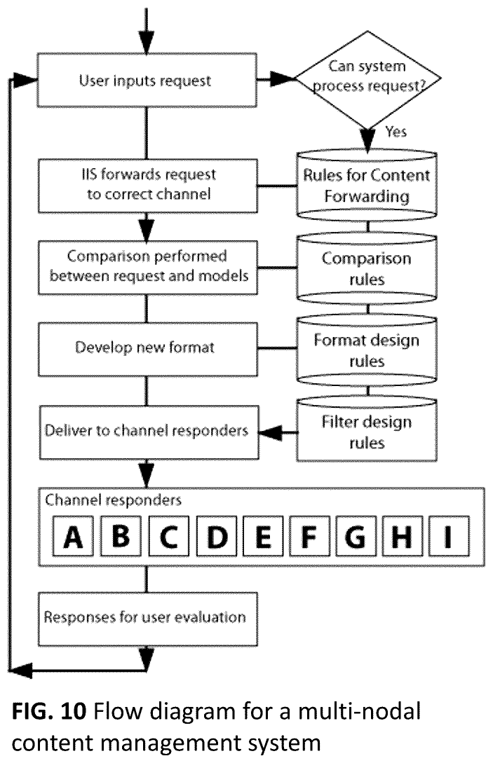

FIGS. 4a-4i are a series of examples of how the system provides tags, badges, icons as lego blocks that can be assembled into templates to crowdsource human user design of nodes, apps, curriculum, and game boards for individual work or collaboration in accordance with an aspect of the invention. FIGS. 5-9 show block diagrams of system functions in accordance with an aspect of the invention. FIGS. 10-14 focus on system integration in accordance with an aspect of the invention.

FIG. 4a shows each node, represented as a circle. Each node contains IDs with associated tags, machine-readable meta-data used to organize and link user IDs, action IDs, content item IDs, keyword IDs, node IDs, procedure IDs, resource IDs. The system uses tags and nodes to enable users to discover and connect with relevant content and other users. FIG. 4a is a simple diagram of one scenario. All nodes on this graph have node IDs. Each node contains IDs, which contain tags. When a human user registers a node, that node serves to organize IDs. Every circle is an ID, whether a university node ID, human user ID, class node ID, project node ID, or keyword topic node ID (shown as an icon). The university node ID contains faculty IDs, researcher IDs, student IDs, staff IDs, and resource IDs, all IDs containing tags. The University X node ID is automatically linked to the Learning Resources node ID with the book icon, which is open to all university nodes. Alex and Joan are Professors of Planning and Computer Science respectively, with tags/connections to many students, not shown in this diagram. Alex, a Professor of Planning, decides to offer a new course on Planning for Resiliency. He registers his course as a node ID within the node of University X and links it to three keyword topic resource nodes, since his course will explore Planning for Resiliency with respect to three domains, public health, climate change, and ecology. Joan sees a new Gen AI Club under Learning Resources at University X to which she and her computer science class link, so all of her students now have the Gen AI Club tag in their IDs. The Gen AI Club also has a resiliency tag, acknowledging the unpredictability of AI tools and how their use teaches resiliency. They link to the Learning Resources Node with their tagline, “Learn resiliency. Join the Gen AI Club.” The IIS recommends to Alex that he connect his class to the Gen AI Club (dotted lines) and recommends to the Gen AI Club to explore contributing to Alex's course on Planning for Resiliency. Though users can query the system, these two recommendations were opportunities about which these users would not have known to query. Through the Gen AI Club Alex discovers that the Club, with students in Joan's Comp Sci Class, has launched a new Project Node for AI Story Animation, and they are exploring the theme of resiliency for their animated AI collage. The Intelligent Integrating System records that the Gen AI Club is an in-person club registered as open only to students at University X and so recommends the Gen AI Club @ X only to students who also have the University X tag, whereas the AI Story Animation Project is a competition for short AI animation segments open to all university nodes. Key points illustrated by this figure: First, the subject invention extends current goal-oriented search technology by recommending options that users would not know about to query. Second, targeted search is augmented by the subject invention, which enables browsing and discovery. Third, as the system scales from the few node IDs in this example to many nodes, the concept of crowdsourcing human initiative and human users underpins its evolution, though graph centrality methods, such as eigenvectors, can be complementary.

FIG. 4b shows how rating and voting can be crowd-sourced to all viewers of content, enabling distributed peer review and content tagging. If a user wants to tag a content item with a particular keyword, and sees no icon, badge for that keyword, the user can type into a search bar or dictate that keyword to search for that keyword, icon, tag. If the searched tag exists, the system serves its icon, enabling the user to tag the content using that icon tag. If the searched tag does not exist, the system serves a generic badge, such as a question mark, enabling the user to dictate or write in whatever badge name s/he chooses to award and to use that write-in keyword to tag that content. In this way the Intelligent Integrating System (IIS) evolves through human use. If multiple users request the same keyword badge, tag, the system calculates demand to determine if the requested tag has sufficient demand to merit creating a new icon and creates icons for new, requested tags for which there is sufficient demand, such that content tagging functionality evolves. New keyword icons are created based upon human use and demand, and can also be used as lego blocks by human users assembling templates, game boards, and other customized graphical user interfaces for browsing, learning, navigation, and group collaboration—frameworks for curriculum, games, or other types of user interfaces to organize content.

FIG. 4b further shows keyword icons, which can be used not only for tagging, classifying, and awarding points to content but can also as lego blocks to structure curriculum, and as icon nodes for pattern recognition and content management. After each content experience, the user is offered keyword icons, which may include, but are not limited to, the icon keywords shown in FIG. 4b. The system crowdsources content classification, peer review, rating, and aggregates all user ratings of each content item to tally its impact in multiple keyword domains in order to compute a total rating to date for that content item. In FIG. 4b all but three icons are keyword tags. The Rorschach inkblot in the upper left corner signifies each user, and is a placeholder for a unique user avatar for each user, and that user's story, until that user defines his/her unique identity with a portrait or as an avatar. The middle POW!™ icon signifies impact and also in one embodiment serves as a portal to the game stack for scorekeeping and impact tracking, though other symbols can be used. Clicking on the bottom right question mark allows the user to ask questions and to develop and upload his/her content using pre-tagged templates. FIG. 4b icons, keywords, tags are symbols for primary keyword nodes, but there can be many more primary keyword nodes than those shown here. Keyword nodes and sub-nodes are added as needed for new content and projects. All keyword topics are discoverable by clicking on the icon representing each keyword, from which the user can toggle from main categories to sub-categories, sub-sub categories and navigate by browsing. Icons serve as nodes to all IDs tagged with that keyword. Icons shown in FIG. 4b are examples that do not limit the scope of this invention.

FIG. 4b shows one embodiment, which does not restrict the diverse scorekeeping options of the subject invention. In this example three “headlights” above each keyword icon, tag, such that a given badge can be awarded in this embodiment one, two, or three times to the same content by the same user—single, double, or triple points awarded to that content ID or action ID in that category. The same badge can be awarded one or more times to an item of content, e.g. conferring single, double, or triple points from the same rater. Multiple badges can be awarded by the same user to the same content or action, acknowledging that this content or action contributes to multiple keyword topics, such as education, health, and the environment. The content tagged receives points from each tag, and the number of times that tag has been awarded, whether with single, double, or triple POW!™ points in that impact category, depending on whether the user clicks on a badge once, twice or three times. In FIG. 4b the user has awarded a content item 3× points for relevance to climate change, a single point for relevance to diversity, 2× points for benefits to the economy, a single point for education, environment, equity, health, innovation, regeneration, and restoration. The user has clicked on the health badge only once, as shown by the single “headlight” above the badge. Clicks, tallied as points by the backend system, are added as points to a scorecard for each content or user or other identifier (ID) for every ID being rated with stars and tagged with badges, icons. Badges not only crowdsource voting but also to quantify scoring, turning subjective opinions of voters into quantifiable points. Primary keywords and their tags can be connected to related tags or sub-tags in a many-layered, cross-connected network of classifications.

FIG. 4b shows rating a single content item by a single user, whereas the embodiment entails ratings of many content items by many users. The total score for this content item ID is the aggregate of all ratings from all users who have rated this content item ID. Because this content item has won points in multiple categories, users can navigate to this content item from multiple keyword nodes. This content item will appear higher in ranking in the keyword nodes where it has received most points, accounting its aggregate points awarded by all users. Each user who tags this content item also receives points for this service, which peer reviews, rates, and categorizes content. Different embodiments of the subject invention may offer different user interface options: alternative ways to choose from among written tags, whether alphabetized or displayed graphically, and alternative ways to click on an icon, badge, or to drag-and-drop the icon badge onto the content. FIG. 4b can also be used as an interface to query each user. What topics introduced in the online recording that you just watched, or the content that you just read, do you want to learn more about? Click on up to five (any number) topics in order of priority. These clicks are recorded both as user preferences and as content keywords.

FIG. 4c shows a further embodiment wherein the system maintains scorekeeping for every ID, such that when a user awards points to a content item ID, additional points are automatically awarded to the user ID of the content contributor and to all user IDs that rate and comment on that content or contribute in other ways. Scorekeeping and point allocation are integral to user engagement and content impact tracking. Badges can be awarded multiple times for the same content, increasing points awarded in that badge category, which are also tallied to compute a total rating. FIG. 4c, in accordance with an aspect of the invention, illustrates how icons, badges can be used in an app where, after performing the common action of rating with one to five stars, the user can then award badges for keyword topics, raising the score of that content and its likelihood of being shown to other viewers interested in the topics where it was highly rated. This user gives this content item points in the climate change 402a category, also for education value 406a and can then click the question mark icon 404 to search for the keyword “forests,” which can be typed in and used, while also suggesting to the system that “forests” may be a keyword used often enough to merit its own icon. FIG. 4c further shows how the subject invention advances scorekeeping methods for impact tracking, game-like incentives, and other functionality. Other activities in the can earn points include watching and annotating online media, using pre-tagged templates to upload content, using natural language to peer review, and using trading cards online or off-line, sometimes as hard copy trading cards for in person delivery or exchange or, in some embodiments, substituting trading cards for online tokens as coupons or currency. In addition, points can be earned for joining the network, writing reviews of content, sharing network content with friends, enlisting friends to join, contributing content, or performing other tasks. Some off-line tasks and activities can earn on-line points, such as: take your children on a hike, attend a meetup on environmental challenges, report on environmental issues in your field or community, install a solar roof, switch to an electric car, contribute to a charity that is part of this network. The diversity of possible point-rewards for real world activities and tasks grows as new sponsors join the network, offering tasks with point rewards.

FIG. 4d demonstrates how tokens can be awarded for a range of actions, both online and offline, validated and credited online. Points can be converted into tokens, which can be exchanged within the system, incentivizing users to contribute meaningful content and engage with the platform. In another embodiment, Embedded Continual Assessment (ECA) converts user content contributions into points earned from contributions to the network, such that numerical points earned by a user for eligible contributions can be translated into contributor tokens and/or flat currency. In another embodiment, the system tracks total points allocated to a node ID, such as a class node ID, and also tracks individual points to student IDs within the class node ID. FIG. 4d illustrates, in accordance with an aspect of the invention, how tokens in some embodiments, whether called Contributor Tokens or by another name, can be awarded for a range of actions in the system, or actions off-line that are reported back to the system, validated, and credited online. The icon for business models, economics, profitability, and earning tokens 420, shown here, is an icon for the entrepreneurship node and a tag for content in this domain.

Earning Contributor Tokens for work that contributes toward addressing global challenges, such as climate change, equity, and food security may be translatable to Contributor Income, which is not Universal Basic Income (UBI), since the level of income depends on how highly a user's contributions are valued. All those who work to address problems and contribute to a sustainable, equitable planet deserve to earn a living based on how much they contribute, defined by crowdsourced scoring, which determines the number of Contributor Tokens (CT) earned. There may be coupons, rewards, or other incentives offered to the user for specific tasks, or as inducements to sign up or log in, or for prizes or other awards. From professors to students, from young people, who want to make this their first job to old people, who want to contribute during their retirement, to gig workers and school teachers who need supplemental income to others motivated to contribute—all can be rewarded based on peer-reviewed scoring of the impact of their contributions. The first points or tokens are awarded for signing up. Other points or tokens are awarded each time the user logs in. The subject invention can be designed, where desirable, to have a game-like look and feel and to apply traditional game techniques to motivate participation: clues, coupons, levels, rewards, pingbacks, points, prizes, and tokens, such that a score tallied is translatable to Contributor Tokens (CT).

Determination of value evolves as in any market-driven system, based on demand and use. Points can be converted into tokens that can be exchanged within the system such that tasks, content, and other assets increase or decrease in value. Rewards are spent and, or distributed to other users or actions or items in the system. In one embodiment of the subject invention, using the example of a professor and his class, the professor ID receives total points tallied by summing, not only the professor's own points, but also that professor's share of points allocated for tasks performed by students brought into the ecosystem by that professor, such that those downstream from each user's direct invitee list contribute a smaller percentage. This method of accounting has many examples in smart contracts, blockchain tracking, and pyramid marketing. Every user profile ID has numerical points, determined by how each user's content is contributed, rated, shared, and used, social influencer status, and other contributions. Value is allocated to contributions based on how much they are used and their cascading impacts. How the value of each contribution evolves over time depends on how often that contribution is cited, tagged, linked, shared, and used, and how system analytics calculates its impact based on crowdsourced ratings, peer reviews and usage data. Points for tasks performed can be converted into prizes and, or into virtual currency or cash bonuses to spend in the ecosystem, or translated to virtual currency at defined payment intervals, and, in some embodiments, translated into fiat currency.

Tokens, rewards can be associated with task performance, and in some embodiments task sponsorship, such that users can perform tasks with associated rewards, claiming those rewards. If a sponsor rewards those who adopt a pair of desert tortoises to breed in their backyards to help save the species from extinction, then tortoise adoption becomes a rewarded task. The value of tasks evolves based on the number of users to perform each task and the need for, and level of sponsorship for, each task. Scorekeeping can tally Contributor Tokens (CT). When the number of users is large enough, functionality can be added also to tally Extractor Taxes (ET), negative points and penalties for those whose activities are reported by contributors as damaging. Though contributors earn Contributor Tokens (CT) by contributing to the online ecosystem, it is assumed that extractors will not join or self-identify, and so must be identified by a large collective of contributors, such as farmers who have been sued by Monsanto (now Bayer) for producing their own seeds. Each farmer sued separately has no power; Monsanto (now Bayer) has won all lawsuits. The system of the subject patent enables formation of coalitions around key issues. Capacity to calculate cascading impacts, both positive and negative, can be used to tabulate Extractor Taxes (ET), as recorded by those who experience damages, such as the Monsanto example. The subject invention, by performing the service of coalition-forming, can enable those groups experiencing class action qualifying issues to organize themselves before seeking legal help.

FIG. 4e illustrates how primary cross-disciplinary nodes link sub-nodes addressing interrelated core topics, facilitating interdisciplinary projects and learning missions. Users can design, register, and lead nodes for various projects. Icons representing different keyword topics and sub-topics, here shown as icons for Climate Change, Ecology, Education, Entrepreneurship, Health are the only non-human registered nodes. Sub-sub-topic nodes have node IDs, even though they are inside primary nodes. These IDs can be for discussion groups. Any user ID can choose icons for a cross-topic node and design, initiate, name, and lead, or not, that node for an interdisciplinary project or learning mission. The subject invention can be used to grow and evolve such distributed online collectives.

FIG. 4f shows how icons can be used as lego blocks to build curriculum templates, with user IDs for participants, content IDs under keyword topic IDs, action IDs for tasks, other IDs and timestamp tags. Further yet, in another embodiment, each user ID is connected to every content ID or other ID through shared keyword tags, represented as icons that can be used as lego blocks to build curricula, game boards, templates, and other customized graphical user interfaces. In yet another embodiment, the system allows for iterative cycles of Embedded Continual Assessment, displaying diverse graphical user interfaces (GUIs) and icons, badges such that bidirectional interactions from the frontend GUI and its human users to backend machine processing are mediated by tags, IDs, and nodes. FIG. 4f icons represent the questions who? what? where? when? how? i.e. who are participants 400, what is the topic, keyword (climate change) 402a, where is work performed 401, what is the timeline 403, and how will you work on climate change (in this case via a sci-fi media project) 406a. Non keyword tags 400, 401, 403, 406b complement the keyword tag 402a. This project node ID is for a fiction-in-action strategy for Alice in Cinderland 406b, a science fiction story about climate change 402a where fiction is used to raise questions. Templates enable users to connect content to related action.

FIG. 4g illustrates an evolving annotation network, where keyword nodes and links grow as users add new content, facilitating browsing and discovery stimulated by Alice in Cinderland. Keyword, node-linking continually evolves as annotators add new content. Larger circles represent word tags, nodes with more content. Lines connect nodes into networks of content with keyword tags. Dotted lines around some nodes indicate trending keywords, currently attracting many users, and growing larger. Proximity of nodes to the Alice icon in the center indicates more direct connections to the story. “Diagrammatic distance” in an annotation network is distorted in this 2D diagram. If the diagram were 3D, there would be more space for nodes close to Alice. Whether 2D, 3D or nD, spatial proximity is merely representation, since network links drive browsing patterns. This diagram schematically segments cultural impact, social impact, and environmental impact to suggest that there are distinctly different types of impacts, but that tradeoff makes cultural and environmental nodes appear (incorrectly) more distant from Alice. With these limitations, FIG. 4g aims to show an evolving keyword network that can be hidden content network connectivity in the backend system or in some embodiments can be an evolving, clickable user interface where primary keywords, such as climate change, can contain sub-topics and sub-projects, such as media production of the story Alice in Cinderland 406b, whose icon can be a sub-project under both climate change 402a and other keywords, such as Education/Learning, such that those in the network can discover Alice in Cinderland by clicking either on the climate change icon or on the learning icon, and perhaps on other icons. A geographic map with pegs can show geographical locations of projects linked to Alice in Cinderland 406b as university projects engage youth in project-based learning-in-action following climate change events, such as fires and hurricanes.

FIG. 4h shows how icon-based templates guide learning activities, from problem framing to research and innovation, supporting personalized individual or collaborative learning. This example shows a three-step curriculum template, using badges, icons as building blocks to assemble project or curriculum frameworks. Many user interfaces are possible for different application domains, learning tools, projects or games. A professor can use icon-based templates to guide classroom learning activities, such as the three stages shown: 1) problem-framing (who, what, where, when); 2) gathering information through questions and background research about the problem and its context; and 3) problem solution, discovery and innovation 407 achieved through research and knowledge-sharing 406a, turning innovation into replicable models 407, and assessment of impact 408. The “who” icon attaches each action to one or more user profile(s) 400. As each student grows his/her own profile 400 by defining the “what” icon, his/her project topic relative to climate change 402a, deciding “where” to start 401 on actions that can be geo-located 401 attached to each action record; deciding “when” to start 403 and critical path for performing timestamped actions 403, all student actions add tags to the student ID and also grow the class node profile ID. Expanding on the climate change topic focus 402a, the student moves to phase 2, addressing process icons that include, but are not limited to, asking questions 404, finding breaks or gaps in knowledge, information, practice, and skills needed 405, and conducting background research 406a. Each of the ten icons above is also a question prompt.
1. Your profile 400—What topic(s), based on your personal experience, interest you most in this domain?
2. Where are you from? 401 Where are the challenges that you want to focus on?
3. When are you starting this project? 403 When did key events occur related to your project?
4. Your project title? 402a Subtopic(s) under the core topic and their keywords?
5. Key questions to address? 404
6. Background research and resources? 406a
7. What's broken that your project will help to fix? 405
8. Innovation (social or technical) that your project aims for? 407
9. Regeneration that your project aims to address? 409a
10. Impact? How will you measure impact? 408
   Customized student learning maps are generated after each student completes a case-based learning template. Icons can be swapped and rearranged to serve new project-based learning curricula. New icons can be developed as new categories, sub-categories and projects are added.

FIG. 4i illustrates one embodiment, one of many possible configurations, of an online game board interface for a Multiplayer Online Learning Game to engage users in real-world projects and tasks, with icons for case study learning and capacity to crowdsource Requests for Proposals (RFPs). The system of the subject invention provides functionality to create a Wikipedia-like collaboration platform to address real world problems, inspired by Buckminster Fuller's World Game, with option to gamify the platform via parallel reality (online-offline) games that engage “players” to tackle real world problems/projects and to earn points, tokens, rewards and, depending on the embodiment, contributor income translatable to fiat currency. This user interface serves as a concept map, offering players and, or students a range of ways to navigate to discover interdisciplinary projects and topics of interest, develop projects related to those topics, contribute content to the online ecosystem, and categorize, rate and share content with friends and colleagues. The top triangle is composed of six icons, starting with the player 400, who first decides “what's broken” 405 that s/he can help to fix. S/he may perceive a need or gap in knowledge 405 and conceive a project to address that need. A user can also choose from a list of “this is broken—can you fix it?” challenges assembled by a network of collaborating organizations. The balance icon 415 represents both equity and social justice, and also the priorities, tradeoffs, risks, rewards, and values that each team's project manifests, including equity in how the team is selected.

FIG. 4i uses the “where” icon 401 to represent “place”—geo-location maps for navigation and record-keeping. When a player signs up, or initiates a new project, the starting location is recorded, together with starting locations of other team members as they join 401. Maps record locations where each solution can be beta tested and, or used. The “place” icon is a portal to geospatial data for each project and geospatial locations and regions 401 relevant to each challenge. The “when” icon 403 represents “time,” from start time to benchmarks and deadlines for task performance—the time when a leader initiates a new project and times when others join the team. The resources icon 406a is a portal for a growing, evolving online library of resources and knowledge, as many users conduct background research for their projects and catalog their research to be re-used for other projects. How each player uses and contributes in the nodes of the icons above contributes to defining the profile of that player.

In FIG. 4i the Triple Threat is represented by the triangle of three icons on the left, below the Rorschach inkblot 400—the triple threat to life on Earth. The game seeks many heroes and many teams in order to target, one task at a time, many aspects of this triple threat:
1. Climate change 402a, from severe storms, from hurricanes to forest fires to sea level rise, heat waves and drought.
2. Death of our ocean 402b from pollution, ocean plastic, ocean acidification and warming from climate change.
3. Destroying the environment 411 that we depend on for food, water—life itself. This Triple Threat can rupture our lifeline for survival of life on Earth. The Triple Threat demands heroic leadership of diverse projects to counter these threats.
   In FIG. 4i the Triple Threat is complemented by a Triple POW!™ [Power Our World] triangle of three icons below the Rorschach inkblot 400 on the right—three ways that human creativity can address the Triple Threat.
1. Fitness 410 is more than health; it engages our uniquely human capacity to innovate and produce fitting solutions to hard problems.
2. Breakthrough innovation 407 can extend current capacity to provide fitting solutions.
3. Beyond innovation, regeneration in every domain 409a, not only agriculture, aquaculture and restoration of pristine water and environments, but also regenerative democracy, equity, free speech—every problem we currently face.

In FIG. 4i the four icons beneath the Triple Threat and Triple POW!™ symbolize method:
1. Smart questions 404 drive each round of play, recycling as many times as necessary to develop fitting solutions that can turn innovation into regeneration.
2. Diversity and equity 412 attract a rich network of collaborators and new ideas.
3. Tracking impact can reward effective contributions 408 with Contributor Tokens (CT) that can, in one embodiment, be translated into fiat currency for productive work.
4. High Impact POW!™ Solutions, achieved by many teams working on diverse aspects of our Triple Threat, are “homeruns” driving each innovation cycle toward regeneration 409a. With a sufficient base of users to identify project needs, the system can match talent to needs.
   In FIG. 4i the Cretan Labyrinth backdrop symbolizes the hero's journey to meet the Minotaur, which in this Reality Game is each user embarking on a challenge that contributes toward addressing one of the many “monster threat” challenges of our world, each with many subset problem nodes and with a critical path for each mission. Both the Rorschach inkblot ID 400, and the Cretan Labyrinth game board, evolve from generic/symbolic to specific as more content is added and interconnected. The gameboard framework of FIG. 4g engages diverse players as co-inventors, and is one embodiment where keyword icons can be assembled into game boards with many potential variations.

FIG. 5 illustrates user steps in accordance with one embodiment of the invention. First the user scans a QR code 500, or opens the app in some other way 501. On opening the app, and when any action is logged, the system records a timestamp and geo-location stamp 502, inferring location, city, country, perhaps other data, such as affiliation or group 503. If the user is attending an event at that time and location, the system may see user registration for the event and record the name and summary information about the event 503. After opening the app, an anonymous user can rate content with 1-5 stars 504, which awards points to that content 505, and the anonymous user can also award badges to content, both tagging the content with keywords 506, and awarding single, double, or triple points in any keyword domain 507. Even if not signed in, the user can contribute to the ID and score of content that the user rates or tags 504-507, but the user cannot see content scores 508 unless signed in. For content tagging, the user has the option to proceed as an anonymous guest or to log in or sign up 509. If the user proceeds as a guest, data from the session is held with a temporary session identifier 510, such that if s/he joins or logs in during this session, the data from the session can be credited to the user profile. If the user chooses to proceed as a guest 509, the system retains rating and tagging actions 504-507, as well as time and location data of anonymous users 511 for data analytics 512 as collective intelligence 513. Guests can receive global alerts, broadcasts 514 and group offers to anonymous users 515.

Although the system provides services to anonymous users, incentives to join include, but are not limited to, connecting to others in the network with similar interests, and for authors, artists and producers, growing an audience for high impact writing, arts and media, from fiction to documentary, from features to shorts, and access to a system for annotating online media and for awarding points to, and earning points for, contributions 516. After visiting the user dashboard to sign up or log in 517, registered users are offered points, tokens, or credits, and access to analytics. Only registered, logged in users can track the impact of their actions, observe the impact of others' ratings of content, projects, or initiatives in the system, find out how content has been rated, track impact, and earn points 518. Only logged in users can comment and receive recommendations 519. Although unregistered, anonymous users can rate content, only registered, logged in users can receive points for rating content and can contribute content. The option to join or log in is offered again 520. Those who contribute content, whether their own or sharing content from another source, can track the impact of their content and enlist their social networks to use, comment, rate, or share their content. In addition, when signed in, protection against bots and spam is activated, including capacity to detect and block malicious users from system hijacking and to secure the system against their entry 521.

Each ID is composed of two collections of tags: a signature (user registration data) 522, and a footprint (user tracking data) comprising all tags added as each ID accrues new tags by performing actions in the system or by being rated, commented on, shared, and used 523. The registered user receives customized recommendations, and may receive offers based on his/her profile. The Intelligent Integrating System (IIS) learns from its human users how to tag content and process records of all actions in the system 524. A content contributor/registrar tags new content when uploading, registering its signature. The system also performs automated tagging, timestamping, and geo-locates the contributor at the time of uploading. Content tagging functionality evolves as users search for tags, badges 525, which are served 526. New tags requested by human users, which do not have icons or have not been previously used in the system pull up a write-in option 527 and trigger calculation of demand. After the user has tagged content with a badge, icon, that tag is attached to the content ID. The system timestamps when each badge, icon, tag is connected to an ID, which is automatically linked to all other IDs containing that tag 528. Profiles expand for users, content, process records, and IDs, and as all items or actions in the system evolve by accruing or removing tags 529.

To upload content, the user can select from the pattern library 530 a template or framework to pre-structure that user's content using natural language processing such that each user can contribute content to the Intelligent Integrating System (IIS) that is partially pre-tagged, making it easier for the system to search, sort, filter comments, compare newly added content with existing content in the system and link users to other users, projects, and resources aligned with their interests 531. Pattern libraries, composed of templates and, or frameworks, provide basic structure, annotation and pre-tagging, pre-loaded in their frameworks and, or templates, including queries, keywords, and ontologies. Pre-tagging facilitates uploading searchable content linked to database categories via keywords and the nodes that contain those keywords in their IDs. The recommender system is informed about user preferences by tracking individual user profiles and node IDs, collectives to which each user belongs, in order to match users to each other and to content, such that both the contributor profile ID and the content profile ID co-evolve 532.

If multiple users request the same keyword, badge, tag, the system calculates demand to determine if the requested badge has sufficient demand to be created 533. Each User Profile evolves through all actions of that user 534. The system recommends nodes of interest to each user. Some nodes, such as a university class node, may not be open or may require permission to join from the node registrar. Many actions can be performed with simple clicks by guest users, such as awarding a rating from one to five stars, and awarding badges with single, double or triple POW!™ [Power Our World] value in points. Once logged in, the user has more advanced options. Each user's keyword tagging of content awards points to its contributor, both weighting the content for recommendation in that keyword category and general points added to the score of the content. The backend system can compare the tag strength profile of each ID with all other IDs in the system to identify a threshold level of similarity, enabling the machine learning system (IIS) to cluster, compare and connect similar IDs for recommendations 535 and other uses 536.

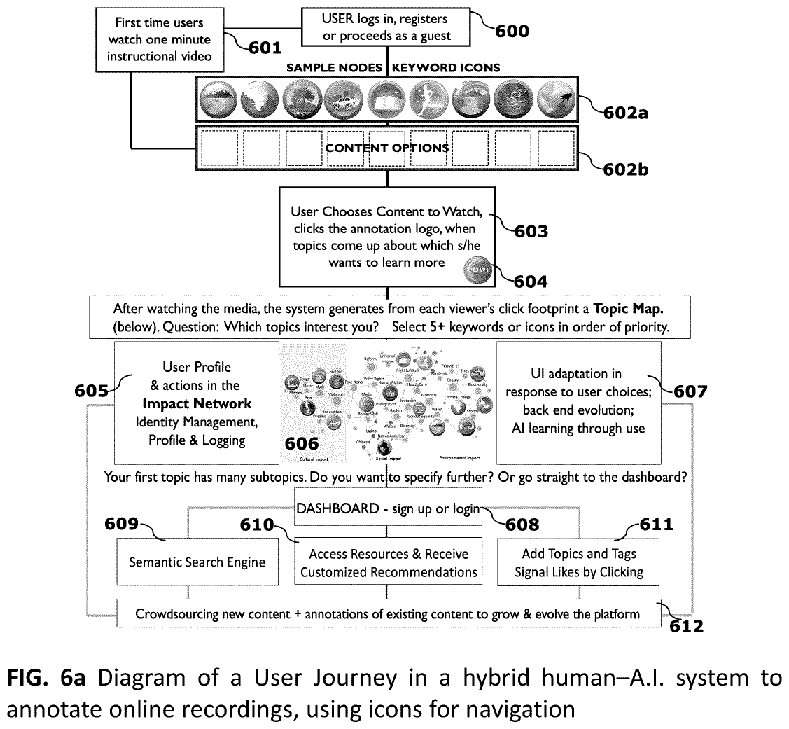

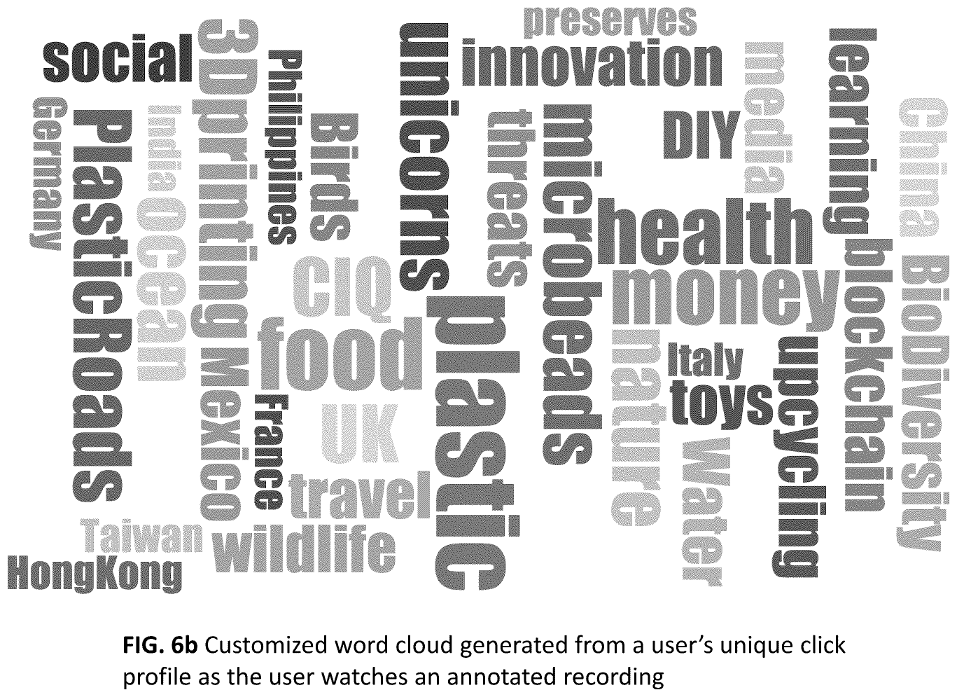

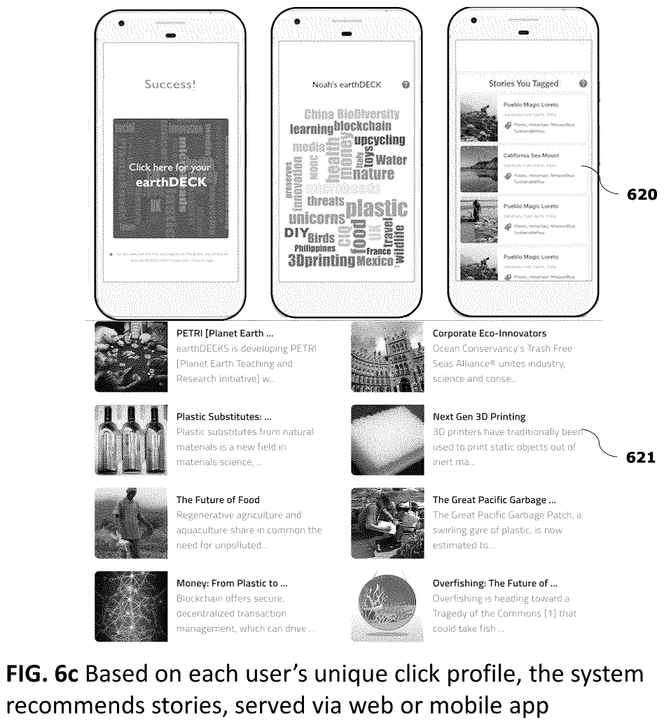

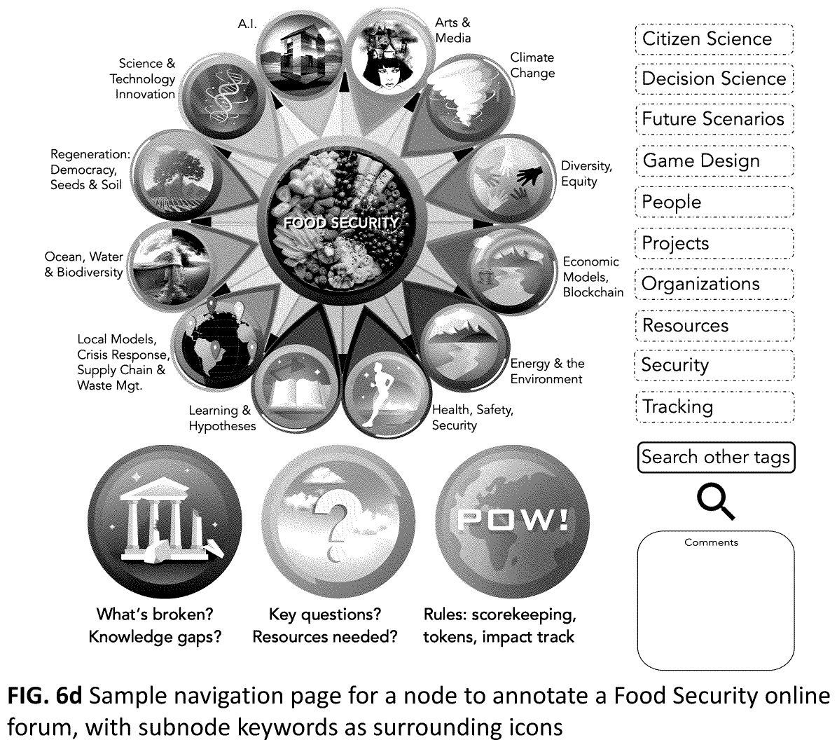

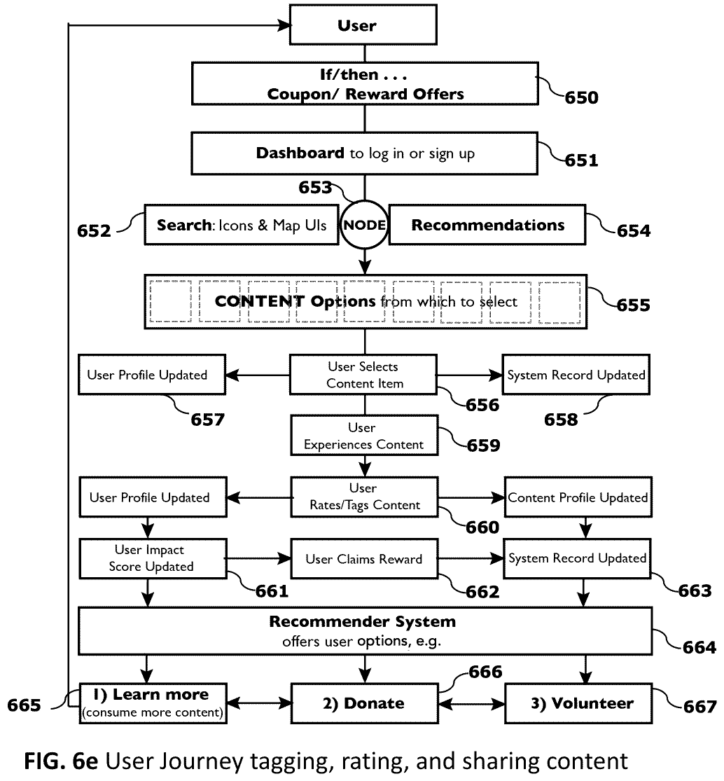

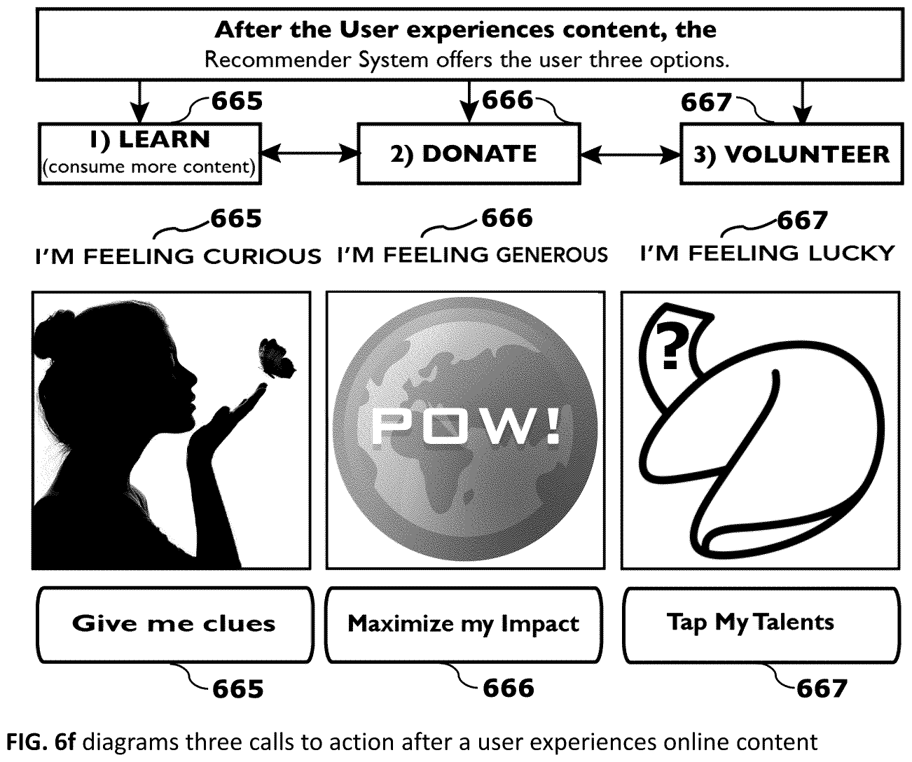

FIG. 6a-6f illustrates functionality of the invention for online content annotation in accordance with an aspect of the invention. The generic system for a user journey in FIGS. 6a, 6b, and 6c shows different types of customized user interfaces that can be generated from each user's unique click footprint.

FIG. 6a shows that a user can login, register or proceed as a guest 600. First-time users can watch a short instructional video for new users 601. Other users can bypass instructions and proceed directly to select content, here showing how the keyword icons 602a in one embodiment can be used to navigate to topics of interest 602b. The user selects an annotated video to watch 603. In one embodiment a symbol on the screen indicates that the recording can be annotated 604. The user can click on the annotation symbol, in this embodiment a rotating Earth globe in the lower right-hand corner of the film screen, whenever content is introduced about which the viewer wants to learn more. In this embodiment, each user click causes the blue globe to flash neon, signaling that the click has been registered by the system. In this User Journey, the recommender system updates the user's profile 605, matching the user's click footprint for that video to keywords for content playing at the time of each click. Keywords may be represented as icons 606, clickable to stories or information on those topics. The user's click pattern as s/he views online media informs the Recommender System of topics about which that user wants to learn more, shows one option for a customized user interface with icon nodes and network links 606 in an embodiment of the subject invention for audio or video content annotation. After a viewer completes watching the media, the recommender system serves the user an optional customized user interface. Since the recommender system can directly serve stories based upon the user's click footprint, user specification of a primary keyword node through this interface is optional. Diverse user interfaces for navigating content can be generated for different user groups 607. What actions the user can perform before being required to log in or sign up is also flexible 608.

FIG. 6a further shows how a semantic search 609 enables diverse users to access resources, receive customized prompts 610, contribute content, and co-evolve a knowledge ecosystem 611, through crowdsourcing 612. Annotation is never complete; each new user is not only a potential viewer, but a potential annotator to comment on content and upload new content, link it to existing content in the system, rate, comment and share all content. The user interface shown does not restrict design for other embodiments. Much as Uber or Airbnb can operate with a single car or accommodation, the media annotation system is valid for a single user and single content item and increasingly viable with more users and more content. Each user's total click footprint grows from a click footprint annotating a single media item into a click footprint across multiple content items—all content viewed by that user in the system, enabling better recommendations. Crowdsourcing human online content annotation can grow a social network of users with a content topic focus, such that users create and share with each other custom annotations on recorded media. Annotations can include text, images, hyperlinks, and related multimedia content. Further, in another embodiment, custom annotations are indexed and searchable, allowing users to discover annotations, other users, and related content using keywords or other tags. Social media functions integrated in each registered node allow users to follow other users, like and share annotations, and receive notifications about updates and new annotations of interest.

FIGS. 6b and 6c show a customized word cloud. When the user clicks on any word in the word cloud, the recommender system serves a menu with a customized collection of stories related to that keyword, as shown in FIG. 6c 220 on the mobile app, or 221 on a web browser. The user can read, comment on, share content, and contribute new content. The word cloud where the user specifies a primary keyword is an optional step that can be omitted or a different interface can be used, depending on the embodiment.

FIG. 6d shows a sample user interface for one embodiment of the subject invention to annotate an online forum such that both those who attended, and those who failed to attend, can later watch the online recording and asynchronously interact with its content and with each other on a topic deemed important enough to merit its own user interface, a navigation page for a node to annotate or browse online content. A ninety-minute online forum on Food Security with multiple speakers and organizational co-hosts introduces many topics, showing how food security crosses disciplines. The central icon, labeled Food Security, links to the recording, which is continually annotated by every user who adds new content linked to the recording, and its topic and subtopics, extending the chat that occurred during the meeting and augmenting the content for subsequent users. The twelve icons, badges, keyword tags surrounding the Food Security icon are clickable portals to their keyword topic nodes, which were noted in the talks and discussed during the forum. The three large icons below the main image, also clickable, prompt the user, who may be a student, researcher or practitioner in food security, with key questions: What are the priorities to address? Where are the knowledge gaps? What are the key questions? What resources are needed? What criteria for progress tracking and impact scoring will best address your priorities? Clicking on these prompts brings up a text field where the user can enter natural language comments, such that the recommender system can learn about that user's unique priorities in order to give better recommendations. In addition to topic and subtopic keywords, to the right of the image are links to non-topical keywords focused on method, such as citizen science, also known as community science, decision science, futures scenario-building, game design, and other elements of the problem-solving process: people, projects, organizations, resources, security, tracking. Each core topic icon may be a subtopic for another icon; repetition of content in multiple contexts provides a range of avenues for content discovery and offers a rich browsing experience. Customized user interfaces can take many forms. This example illustrates, but does not limit, the configurations or options for embodiments of the subject invention.

FIG. 6e shows how, before logging in, optional coupons or rewards may be offered 650. A range of incentives can be offered to sign up, from generic, as when an online retailer offers a general gift card or coupons to purchase products that merit endorsement, such as sustainable brands that exemplify fair trade, equity, or local organic production. When aligned with the mission, the IIS can support market research, as when a sponsor offers coupons for sustainable vacation accommodation options, enabling the sponsor to assess preferences. Or offers may be tied to specific choices responding to his/her navigation in the online environment, which may include, but are not limited to:
1. selecting keyword icons;
2. receiving customized recommendations;
3. navigating a geographic map or concept map user interface, enabling the user to explore areas or topics of interest; and
4. a search bar, enabling the user to search for a keyword, icon not displayed. Any of these four navigational options enables the user to discover a range of content, resources, and opportunities responsive to his/her interests.
   Each user's content selections update in the system record, not only for that user's profile but also for content IDs of all content items selected. The user then arrives at the dashboard to sign up or log in 651 to perform requested tasks. Once logged in, the user has the option to search 652, which updates recommendations from the user's last experience in the system based on this new query. His/her affiliation with one or more node(s) 653 also affects the recommendations provided 654 and the content options shown 655. User response to those content options, from selection 656 to consumption 659 to rating and tagging content 660 or claiming reward(s) for performing other task(s) 662, trigger user profile updates 657, system record updates 658 and also update the user's impact score 661, all of which update content item profiles and user profiles, increasing the knowledge of the recommender system 664. When a user, viewer experiences a content item, whether by reading, attending an online event, watching a film or performing an action in the real world that is reported back to the system, after experiencing that content item, the user rates it relative to keywords, from climate change to education, from health to the environment and social justice. Tagging the content item with badges categorizes that content by keywords, such that the system learns not only about the content but also about the user. Each cycle of the user journey ends with one or more user calls to action, such as the three options 1) Learn 665, 2) Donate 666, 3) Volunteer 667 shown at the bottom of FIG. 6e, described in FIG. 6f.

FIG. 6f shows one embodiment of the invention wherein, based on each user's profile, at the end of each content experience, the viewer is presented with three calls to action, such as those shown in this sample interface: 1) Learn, 2) Donate, 3) Volunteer. The embodiment of the subject invention for annotating online meetings or other content focuses on the first option. If the user has not yet joined and logged in, s/he belongs in the network of anonymous, non-logged in users, who can anonymously rate, tag, classify, and annotate content, providing user data for analytics on this large anonymous pool. Early embodiments focus on the first call to action, Learn, as in the annotation embodiment described because, like an Uber or Airbnb, which has functionality with only one driver or accommodation, “Learn” can start small, whereas matching donors or volunteers to projects requires a critical number of users and projects. Such functionality can be added later. The three basic categories 1) Learn, 2) Donate, 3) Volunteer can be expressed in a range of ways. “Learn more” 665 can become “I'm feeling curious” 665 or “Give me clues” 665, which cycles back so the system can recommend, and the user can experience, more content 665. The recommender system, based on the user's profile and interests, recommends content and the user repeats the cycle of selecting, experiencing and rating/tagging content. “Donate” 666 can become “I'm feeling generous” 666 or “Maximize my impact” 666. The recommender system, based on the user's profile and interests, recommends ways to contribute for those who can provide financial or other resources. The third option to “Volunteer” 667 can be varied to “How can I work on this?” or “I'm feeling lucky” 667 or “Tap my talents” 667, represented by a fortune cookie, suggesting that users who volunteer may be rewarded, either by meeting others with related interests or discovering new resources. The recommender system offers ways for each user to get involved, contributing knowledge, resources or talent and experience. These three calls to action are illustrative, since there are other options than in FIG. 6f. Other icons can be represented on a mobile device touch screen, or other user interface and are not limited to the interface shown.

FIG. 6f shows a third call to action that, in one embodiment, can match talent to projects. Suppose a user is a hip-hop artist. He watches the film 16 Bars about a hip-hop artist who teaches a music program in a prison. This viewer notes that one of the film's key themes is music. He tags this film with the Music icon and comments, “What a great idea to enable prisoners to make music.” In FIG. 6f he chooses, “Tap my talents” and looks for ways to contribute his music talent 667. The system recommends program directors at prisons, who were inspired by 16 Bars and want to bring their prison into a network of prisons with music programs. The musician proposes to one of these prisons a music program that he can lead. His proposal is accepted. The system records a new prison music program as a positive impact of the film 16 Bars and includes this new program as an option under “Maximize my Impact” and, or “Donate” 666 for donors who want to fund Prison Music Programs. This user prompts the system to crowdsource a list of other prison musician volunteer opportunities that are added to the list of opportunities under “Tap my talents” or “Volunteer” 667. Cycling back to the first category, “Give me clues” and, or “Learn more” 665, the system updates the impact of 16 Bars and the success of the new program that it inspired, so that under “Learn more” users can now learn about the impact of these new programs. Users who are not yet ready to sign up can learn more about the platform's mission. Or they may have signed up but not be ready to donate or volunteer. FIG. 6f examples do not narrow the scope of the subject invention to any particular user interface concept or design.

FIG. 6f further shows an embodiment where human users can receive prompts from the IIS as “fortune cookies” or presented in other ways, such as clues to solve a challenge, and, or mission prompts or challenges with a game-like look and feel. The IIS supports translation of real needs into challenges to attract talent, engage storyboarding generated by the system and customized for each user, offer a range of incentives for embarking on challenges and rewards for completion, as well as potential for individuals or teams to score points, so scorekeeping is gamified impact tracking. Prompts to a human user can be customized for educational settings to make learning game-like and fun and can support other users to co-instigate a game, define its obstacles, and discover other like-minded players recommended by the system as possible teammates.

FIGS. 7a and 7b are the same flow diagram with different labels, illustrating parallel embodiments in two embodiments of the invention. FIG. 7a labels to describe the content management embodiment, which also entails Requesters (Content Consumers) and Providers (Content Providers) as in FIG. 7b. All applications of the subject invention require content management. All serve distributed, crowdsourced contributors and provide for tagging, classifying, and rating various types of online content, products or services. Capacity to tag users, actions, and all records in the system, enables the Intelligent Integrating System to make recommendations also for transaction exchange networks, such as requester-responder systems to crowdsource Requests for Proposals (RFPs), or to convene virtual or in-person meetings or conferences.

FIG. 7a illustrates an embodiment for community management of online content in a Mobile and Online Application, serving and receiving content from diverse devices to an Intelligent Integrating System 700 via user nodes 701 wherein the knowledge platform may include, but is not limited to, content producers and their audiences 702, reviewers and analysts 703, raters, commenters, producers, providers 704, topic experts, both requesters and providers 705, entrepreneurs and implementers 706, and domain experts and developers of learning and other media content 707. These diverse communities can have different levels of access, permissions, and rights of authorship, and, depending on the embodiment, points earned can be used to define each user ID access level, opportunities, and other rewards. User interactions are tracked and recorded, enabling personalized recommendations and content discovery and enabling the IIS to provide customized updates and reminders. When any individual user, or group of users, contributes to the network, tags determine whether that contribution should be shared with the entire network or restricted in any of many ways to one or more node(s), project team(s) or subset IDs of the network. Content distribution may focus on regional consumers if content is regionally specific, global consumers, or beta testers or a particular interest group as specified by tags in their IDs. A story may attract the attention of filmmakers, local entrepreneurs, groups, organizations, programs that have already established topic nodes, impacted communities, and game developers. Beyond interest groups, since logged in users can see new content shared with their networks, users who want to receive alerts will be alerted to new contributions in their domain of interest. Templates enable the machine to compare content, cluster related contributions, create a taxonomy of users and data 708, a content navigation map 709, and an outreach framework to grow the user network 710 via a web and mobile app receiving from mobile and other platforms 711, including external content feeds 712, with links to other tools and applications 713, automated systems 714, and mirror networks 715. In this example, the subject invention is applied to a diverse network of content providers and consumers, including media producers and their audiences, writers and their readers, professors and their students. Content is shared by writers, media makers, project producers and leaders of initiatives, organizations, enterprises and others. Content, or competition entries, can be uploaded and routed to different user nodes, as specified, for rating and tagging by different audiences. User contributors generate content that others tag, use, and share, augmenting the original value of the content by adding reviews, comments, rewards, and tags. User ratings and tagging continually informs the IIS, not only about how content is being rated and tagged by its consumers but also about how content is being used. For debated topics, this record shows how data is used to support or refute an argument or to teach critical thinking.

In one embodiment, the system comprises a hybrid human-A.I. recommender system for online content annotation, which includes a processor and a non-transitory storage element coupled to the processor. Encoded instructions stored in the non-transitory storage element configure the system to receive a user ID registration of an online recording as a project node ID for annotation, converting that project node ID into a machine-readable identifier (ID). In another embodiment, the system receives a user selection to view an online recording registered as a project node for annotation and serves the online recording selected by the user for annotation, add the node's tag to the user ID and add the user's tag to the node ID for this annotation project node; and update the user's profile ID and the node's profile ID with new keyword and other tags based on this interaction.

FIG. 7b is the same diagram as 7a, but relabeled to illustrate a second core embodiment of the invention, and how the system 750 handles a generic user request. Requesters use templates preloaded with tags, but requesters can also manually title and add tags to their requests. The system aggregates tags into a project ID for each query or request. When used for a task distribution network, tasks are distributed to first qualified responders, canceling, and so avoiding duplicate responses. The system must first determine whether it can process the request or not, and, if yes, then apply a series of matching algorithms and forwarding rules to process the request and deliver it to qualified responder(s) based upon tag strength profile matching of both requesters and responders. A basic embodiment of the present invention serves a range of applications requiring coordination of large numbers of people, ranging from distributed disaster recovery involving a range of people with diverse skills, to crowdsourcing RFPs wherein the Intelligent Integrating System (IIS) operates in a client-server model. A responder logs in and responds to a task request as shown in this flow diagram. After performing the task, the responder receives points, credits, incentives or other remuneration. Effective performance triggers new offers from the US.

FIG. 7b illustrates the subject invention where the Intelligent Integrating System 750 serves a diverse set of user nodes 751 and network of user communities 752, developers, stakeholders 753, producers, providers 754, requesters, receivers 755, entrepreneurs, implementers 756, task performers with domain expertise 757 or products that address requester needs. A taxonomy of users and data 758 shows what resources are available and a content navigation map 759 shows where these resources are located, and user network algorithms 760 enable users to receive alerts about opportunities and deadlines, set preferences for alerts and other notifications, and manage content interactions and exchanges across diverse devices and platforms. The Impact Tracker checks off tasks performed, annotates project status, triggers broadcast alerts, filters and sorts content, tracks worker performance and retains profiles of workers for future tasks. Developers, stakeholders 753 can provide pre-loaded rich content to the knowledge platform, serving and receiving from diverse devices 761. FIG. 7b further shows how the IIS enables rapid exchange of information within a transactional requester-responder system. The system geographically locates items, people, tasks, and resources in space and time, with navigation paths through geographic maps or concept maps comprising linked icons, or by browsing keywords in a Mobile and Online Application that enables rapid exchange of information, from one to some or many, from some to some or many, and from many to many. The IIS tracks and records usage by tagging items not only by content but also by time and place, including, but not limited to, human user profile ID tags, geographic-locator tags, timestamp tags, and tags specifying the user's role. The network of links to user actions in the system enables in-person, online, asynchronous exchanges and transactions.

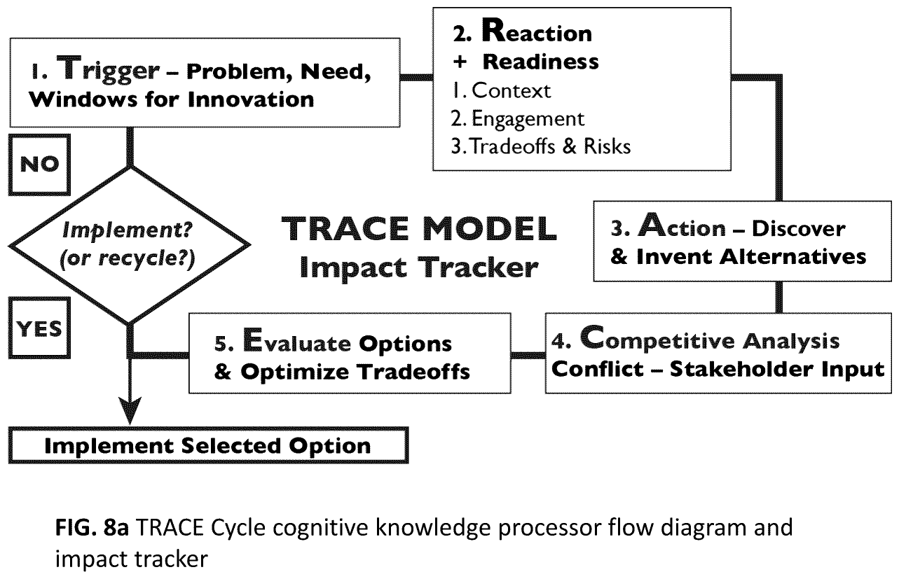

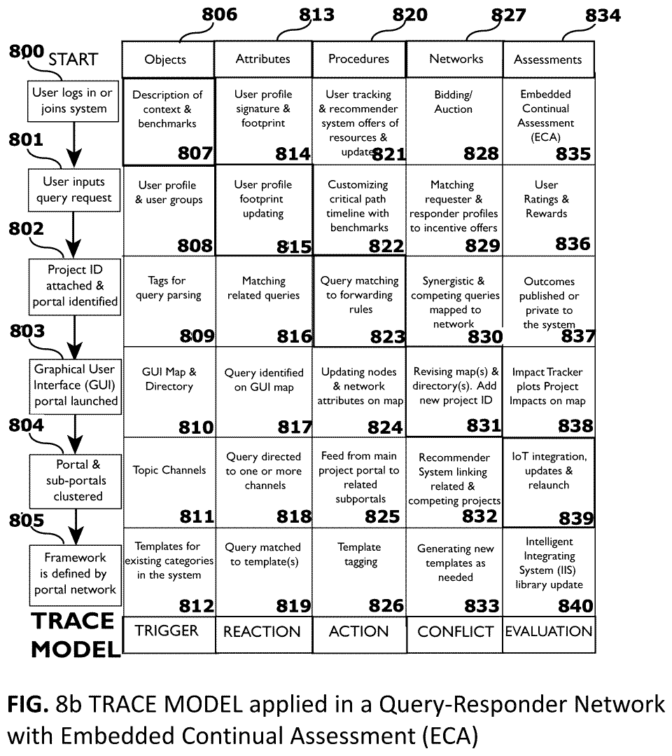

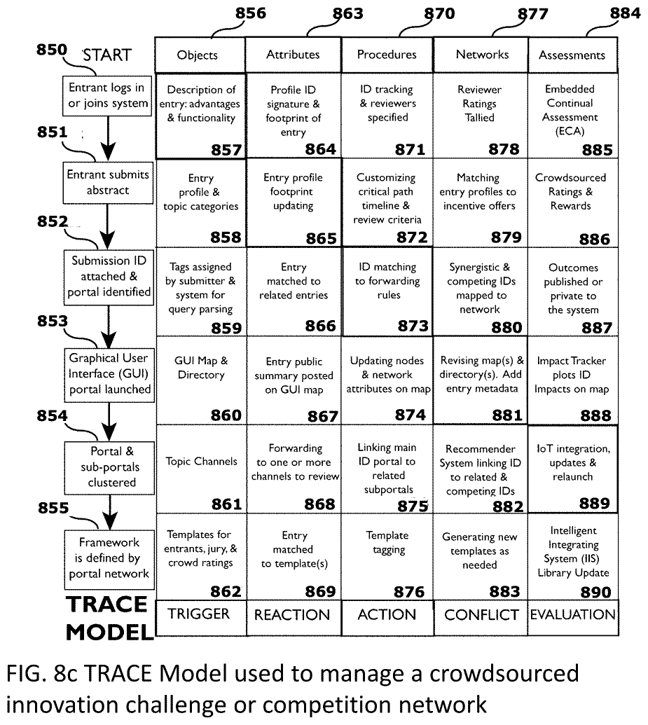

FIG. 8a shows one generic embodiment of the subject invention for a requester-responder system wherein the five steps of the TRACE Cycle (an acronym for the five key steps), enable users to respond to prompts using pre-structured and pre-tagged templates, enabling content to be easily parsed, keyword-tagged, clustered by the machine, and compared to contributions of other users such that impact can be tracked.
TRIGGER (top left) initiates or renews a project cycle. The Trigger is a prompt and, or, in a gamified system, can have other names, such as “Code Alert.” When a user, gamer, or task requester identifies a problem, need, or window for innovation and presses the trigger “Submit” button on a user interface, a GPS system records the user's location and timestamps the start time and place. Templates enable users to enter queries, task requests, or other triggers that are tagged or parsed.
REACTION—readiness to tackle the challenge, combined with understanding of the context, means of engagement, tradeoffs and risks. Here users can add comments, notes, questions and background about the trigger problem, project, context, and related background research.
ACTION—challenges the user to discover or invent options that can be reduced to task specification, critical path, workflow, such that the machine can identify clusters of people and resources to perform needed tasks.
CONFLICT—competitive analysis gathers stakeholder input and identifies, tags competitive or collaborative projects, conflicts, tradeoffs, contributor value (rewarded in Contributor Tokens) and extractor cost (penalized with Extractor Taxes), and related performance data.
EVALUATION—At the conclusion of each task cycle, when points have been rewarded, the system provides a Project Status Update. Users report on the status of their tasks. Depending on the nature of the task, others may provide ratings. Evaluation may include the number of requests closed by a team leader, and assessment of success in closed task requests.

FIG. 8a shows a flow diagram for the TRACE Cycle, wherein iterative cycles update the Intelligent Integrating System, enabling machine learning from user actions, system evolution and impact tracking. The TRACE Cycle underpins story-impact cycles where users, inspired by films they see, or content they read, can not only rate, categorize and comment on content, or upload new content, but can also perform services in the real world related to that content. Users can receive points, translatable into Contributor Tokens and, in one embodiment, into fiat currency in exchange for reporting their validated or peer reviewed offline real-world services online. Accrued points can be exchanged for rewards and offers based on each user's profile and contributor status, and the current value of services performed, guiding a plurality of users with divergent views toward convergent solutions, where convergence is defined as optimizing diversity such that contributors perform diverse tasks, play different roles, contribute different content and expertise, and consensus is not required. The Evaluation stage of the TRACE cycle enables system updates, recycling back to the TRIGGER to relaunch the next cycle. Embedded Continual Assessment (ECA) tracks the value of contributions, assessed by crowdsourced tag-voting, and by links from each contribution to all entities with identifiers (IDs) including all users, actions, items, and other resources subject to IIS record-keeping and the number of timestamp indicators of use.

User-agent hybrid functionality for Embedded Continual Assessment (ECA) enables the system to evaluate the effectiveness of matches of individual user IDs to other user IDs, to content IDs, project IDs, and resource IDs. In addition, the machine assembles ID clusters of users, projects, organizations, resources, and their keyword tags. On request from a human node registrar, the Intelligent Integrating System can recommend a cluster, with potential to be registered by a human user as a node, combining user profile IDs, keyword IDs, other IDs, timestamps, geographic location tag criteria, such as x number of user IDs within a given distance from a location with expertise to address project requirements at that location. The system tracks the impact of each individual ID in a node.

FIG. 8b shows use of the TRACE Model for content management of the subject invention, focusing on the actions of the Requester. Once a Requester joins or logs into the system 800, the Requester inputs a query or request 801. The system attaches a keyword, which identifies the Project ID and node ID 802, which opens the user interface for that node 803, showing relevant sub-node IDs 804. A primary node for one query may he a partial match for another query. A framework for lodging a request 805 structures the Requester's data entered into the Intelligent Integrating System (IIS) as objects 806. The Requester's description of the query context and objectives 807 is augmented by attributes 813, procedures 820, networks 827, and assessments 834, which are recorded to the Requester's existing profile ID in the system. The system recommends links for the Requester to closely matched user nodes 808. The Requester's query is manually tagged by the Requester when entered into the system. The system also performs automated tagging, timestamping, and geo-locates the Requester. User and system tagging together support query parsing 809. The Requester's query is matched to a primary node, both by Requester selection and, or by automated matching, serving up a graphical user interface (GUI) with a backend directory 810, which includes keyword topic nodes 811, and templates for existing keyword nodes in the system. Queries are parsed and matched to related queries 816. Each public query may be tagged on a concept map and, or by its location on a geographic map 817. The query is routed in the system, directed to one or more nodes 818 and may be matched to one or more templates in the system 819. The above steps for matching, linking and grouping into nodes by humans and, or clustering by the machine, build a framework for problem-solving 820.

User tracking enables the system to offer both Requesters and Responders recommendations of resources, updates, and opportunities 821, customizing critical path timeline with benchmarks 822, matching the query to forwarding rules 823, which update the nodes and network attributes on the map 824, feeding from each primary node to its related sub-nodes 825, with pre-tagged templates associated with each query such that tasks can be tracked in the system 826. All user and system actions configure the networks of the Intelligent Integrating System 827, partially represented in one embodiment as a graph database. Bidding by Responders in an auction produces well-matched responses to each Request 828. User profile IDs of both Requesters and Responders can be matched to incentive offers 829 to augment the attractiveness of a given bid. Each query launched or completed has a project ID profile, enabling synergistic or competing queries to be tagged and mapped to the network 830, such that maps and directories linked to each query can be revised as called for by each query, project profile 831. Mapping of a given project ID to the resource IDs of the Intelligent Integrating System (IIS) enables the IIS to launch a recommender system linking related and/or competing projects 832 and generating new templates as needed 833. The Assessment, Evaluation stage 834 of the TRACE cycle enables system updates that relaunch the cycle, relaunching as many iterative problem-solving cycles as necessary. Embedded Continual Assessment (ECA) 835 comprises the total capacity of all actions in the system to adapt and respond to continual impact tracking. User ratings and rewards 836 can be attached to project outcomes, which can either be published or remain private to the system 837. The Impact Tracker plots all impacts to the map and backend database 838, although only published impacts are shown. The system triggers Internet of Things (IoT) system updates, as when a smart device alerts a region that a power shutoff will soon occur 839, updating the Intelligent Integrating System (IIS) Library 840.

FIG. 8c clarifies the complementarity of user tag strength profile and content or competition entry tag strength profile. Although “linear competitions” (call for submissions, review of submissions, and awarding a prize) are widely used to attract talent to address innovation challenges and to crowdsource solutions to problems, what has been missing is the collaborative intelligence system of the subject invention, redefining crowdsourcing beyond the traditional formula of a single call and linear competition. What is needed is a system to support ongoing, rolling crowdsourcing around a given problem, where human decision-making is complemented by machine capacity to cluster synergistic submissions and to track the impact of each innovation through time. In one embodiment, the Intelligent Integrating System (IS) can manage a crowd-sourced competition or problem-solving challenge, such as a request for proposals or competition with rolling or repeated rounds of submissions, or entries wherein a TRIGGER may, at pre-selected times or intervals, prompt a broadcast to crowdsource many potential contributors, as when a granting agency or an organization manages a crowdsourced Request for Proposals (RFP). An entrant can join or log in to obtain a user ID 850 and submit an abstract 851. The system attaches tags to each submission ID 852, opening the icon, keyword, node, portal identified as the best match for that submission 853, and also linking the submission to other relevant nodes and sub-nodes 854. Any given keyword, icon, node in the system can be the main node for an RFP, and responses to that RFP, if that keyword is the best match for the topic. Partial matches can be sub-nodes under the main node, category 854. The main node offers the submitter a framework 855 to structure submissions such that the Intelligent Integrating System (IIS) can perform updates 890 and cluster mutually synergistic submissions.

This framework starts with the submitter's description of the features of his/her submission and its advantages 857, the signature of the submission. The footprint of the submission profile ID grows as the submission is tagged by reviewers 858. The system recommends links to related keyword tags 859. Each submission is not only named and tagged by its contributor/responder when submitted to the system but also receives automated tags from the system and manual tags from human peer reviewers. Tagging defines the submission ID 864. The TRACE framework may be used in other ways: to share media a user selects the media template 855. Objects 856: Short Film, associated articles and workbooks for learning. Attributes 863: Instructional; Topic—Social Justice; Length of media—20 minutes; curriculum module lesson plans—two weeks. Procedures 870: non-profit licensing fee; field experience opportunities for additional fee but scholarships are available. Networks 877: universities, non-profit organizations focusing on equity and social justice. Assessments 884 include endorsements from experts, peer reviewers and impact to date. FIG. 8c illustrates an embodiment that is triggered by a system broadcast to many potential Responders. For example, a granting agency or an organization managing a competition challenge, could broadcast a request for proposals (RFP), or competition challenge guidelines. A competition entrant can join to obtain a user ID or log into the system 850. The competition entrant submits an abstract 851. The system attaches a submission ID to the competition entry 852, opening the keyword node identified as the best match to the category of the competition entry 853, linking to relevant sub-node IDs 854, which may be primary nodes for other entries, but are partial matches for this entry, and so contained within the primary node ID 853. The primary node offers the competition entrant a framework 855 to structure the entrant's submission for the Intelligent Integrating System (US), details under objects 856 that include description of the features and advantages of the competition entry 857, enabling the system to recommend links to related keyword topics, categories 858. All tagging supports entry parsing 859. The competitor's entry is matched to a primary node, either through crowdsourcing or by automated matching. The system serves a graphical user interface (GUI) linked to a backend directory 860 that includes keywords and tag links to other topic keyword nodes 861, templates for entrants, crowdsourced peer reviewer ratings of entries 862, expert jury attribute tags 863, procedure tags 870, network node IDs 877, and assessment tags 884 such that the Intelligent Integrating System (MS) can cluster mutually synergistic entries and perform updates 890.

This framework starts with the competition entry's signature component of its profile ID; its footprint grows as reviewers review and tag or provide natural language comments on the submission 864. Each entry is not only tagged by the entrant when entered into the system but also receives additional automated tags from the system. Each entry submission profile II) Footprint evolves as the entry is rated by expert jurors and, or crowdsourced voting 865. Tagging serves to identify and group related entries in the system 866. Each entry may be tagged on a concept map and, or by geographic location of the entrant 867. The entry may be routed to best qualified human reviewers and, or to A.I. automated review 868, matched to one or more templates 869, passed to procedures 870, including tracking and reviewer selection 871, customizing a critical path timeline and criteria for review 872, matching the entry to forwarding rules 873 that update its nodes and network attributes on the map 874, wherein the primary node for each entry is linked to related sub-nodes 875. Templates associated with each unique competition entry are tagged to facilitate assessing each entry relative to the request for proposals or competition guidelines 876. All user and system actions configure the connectivity networks 877 of the Intelligent Integrating System. Ratings of each entry are tallied 878, and entry profiles may be matched to incentive offers 879 that augment an entry's potential for funding and implementation. Each entry ID contains a summary with a summary profile IDs with tags, enabling synergistic or competing entries to be linked via tags to its node 880, such that maps and directories linked to the entry can be revised and metadata added as called for by each entry profile 881. Mapping each entry to the resources of the Intelligent Integrating System (IIS) enables the IIS to launch a recommender system matching related or competing entries 882, generating new templates as needed 883. The Assessment, Evaluation stage 884 of the TRACE cycle triggers system updates that relaunch the next iterative cycle. Embedded Continual Assessment (ECA) 885 connects each crowdsourced entry to impact tracking. Crowdsourced peer review identifies entries deserving rewards 886. Depending on the guidelines of the competition or request for proposals, outcomes may either be published or private to the system 887. The Impact Tracker plots all entry IDs (whether visible or not) to the map and backend database 888, but only published impacts are shown. The system triggers Internet of Things (IoT) system updates as, for example, when a project on water conservation in agriculture, or marine acidity or pollution is monitored by a sensor network 889. All actions described above are logged and trigger Intelligent Integrating System (0S) library updates 890.

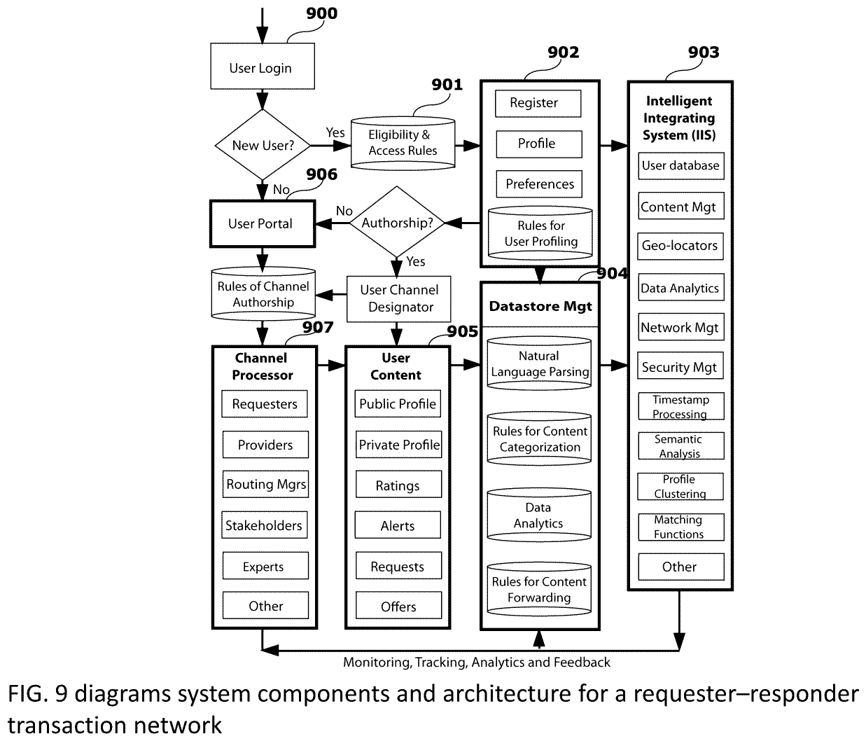

FIG. 9 illustrates a user setup sequence for an embodiment designed for large numbers of users participating in a distributed social network or multiplayer online game. Once the user selects topics to search, the system asks if that user wants to specify further or proceed to the dashboard to sign up or log in. The user logs in 900 to a system that has both public access and multiple levels of privacy, depending upon the user's level and role in the system. The system automatically checks eligibility and access rules 901. The system comprises encoded instructions wherein when executed, the system is configured to: receive a request from a task requester, tag said request, apply a query-forwarding rule to forward the tagged request to at least one best match receiver for the keyword topic or node, such that the tagged request is sourced to at least one responder. Rules for user profiling 902 enable each user to set up a profile including, but not limited to, email address, through which the system can determine whether that user is approved to register or not. Though email address serves as the user ID, signup also requires first name, last name, affiliation, position, mobile phone (automatically recorded if the user registers or logs in from a mobile phone), website(s), password, and preferences. The identity management component 902 logs all actions in the system. The Intelligent Integrating System 903 maintains a taxonomy of user profiles, which evolve as users interact with each other and with the system. Users contribute content of different types to the Intelligent Integrating System and receive recommendations based on their profile IDs. The IIS tracks user permissions and levels of access recorded in the datastore 904. Users have different levels of authorship based on the level of access they achieve through their contributions to the system, determined by the user ID 905. When users sign in, they pass through the user portal 906, are matched by the processor 907 to resource IDs, content IDs and other user IDs, according to their profiles, history of use, preferences, and level determined by points received for content shared and tasks performed in the system. The system tracks how requesters and responders use identifier tags for user profile tagging, topic keyword tagging, timestamp and geographic-location tags and other tags, tracking usage by one or more of the following tags: geographic-location data, timestamp data, keyword tagging, and user profile.

FIG. 10 illustrates how a basic embodiment of the present invention serves a range of applications requiring coordination of large numbers of people, ranging from distributed project manager user IDs to large number of diverse contributor IDs to large events and crowdsourcing competitions wherein the Intelligent Operating System (IIS) operates in client-server mode: a Responder logs into a client and obtains a task request from a Requester. After performing the task, the Responder receives payment, peer review, verification, incentives, or reward points. Each advancement triggers new instructions from the system. In different embodiments of the invention, Requesters and Providers, or Guests and Guides, or other Senders and Receivers can register, via the web or mobile devices, to contribute and receive instructions, clues, and information customized to their user profile. When a Responder registers online to provide a product or service that can be optimized by comparing Responder profiles, the Responder is directed to set up a profile II) and preferences. Responders can log in, either via a custom website e g. “My [service name]” or, for small service communities, via a unique service node on a general website, established to serve the subject invention.

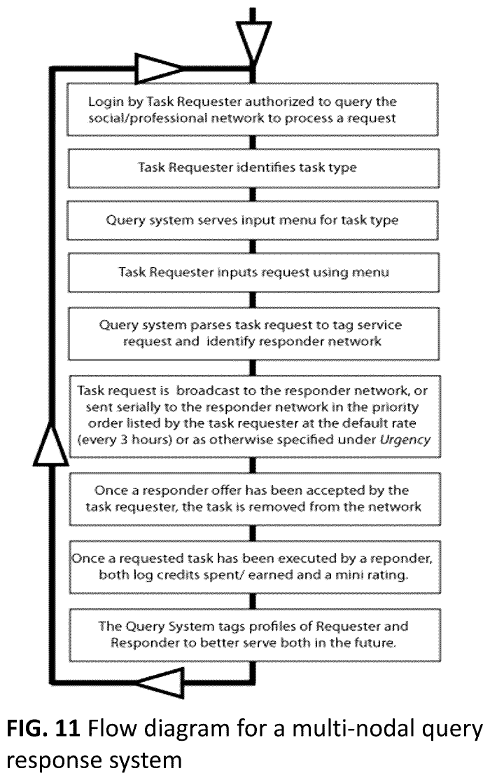

FIG. 11 illustrates how the content management embodiment requires the functionality of other embodiments. The content management embodiment and the requester-service provider embodiment are complementary, since content management also entails Requesters (content consumers) and Providers (content creators, providers, critics, or sharers). Task performance in the second embodiment requires the content management of the first embodiment. FIG. 11 further illustrates how the system handles a generic user request with a logical flow diagram from the Task Requester to the Responder in a transactional embodiment of the subject invention wherein the machine can perform various automated procedures on natural language content submissions and responses including, but not limited to, aggregating, clustering, integrating, linking to user profile IDs or publishing for public human peer review and rating, retaining as confidential, performing statistical analysis, tagging, and tallying. Query generators operate on data stored in any non-transitory terminal with computing capability and memory. Client software includes natural language analyzers able to receive and cluster, rate, search, tag and perform other operations on natural language input.

FIG. 11 further illustrates how, in one embodiment, the Intelligent Integrating System (IIS) can manage rolling, or iterative, crowd-sourced responders to requests and task challenges. Although “linear competitions” (call for submissions, deadline to submit, review of submissions, and granting of awards) are widely used to attract talent to address innovation challenges and to crowdsource solutions to complex problems, what has been missing is the collaborative intelligence system of this patent where crowdsourcing moves beyond the traditional formula of a single call and onetime crowd response typically used for competitions. The subject invention provides a system to support ongoing, rolling, crowdsourced contributions to continually updated or new problems, with benchmarks, capacity of the machine to cluster synergistic contributions and to offer incentives and rewards. When used to crowdsource responses to a Request for Proposals (RFP), or to match a requester to a responder/provider with best expertise for the task, the reconfigurable crowd-sourcing requester-responder system follows the steps of: (1) receiving a submission; (2) tagging the submission into at least one of a cluster (machine-defined), keyword category (auto-defined), node (human user-defined), or sub-node; (3) applying a content-forwarding rule to forward the tagged submission to at least one keyword topic, or to at least one responder identified by the IIS recommender system as a close match to the required credentials or to qualified responders as specified; (4) tracking how requesters and responders use identifier tags for user profile tagging and keyword tagging of topics, geo-location, timestamp, and user profile; and (5) publishing the response such that users can comment, rate, and, or vote, or retaining as private if so specified.

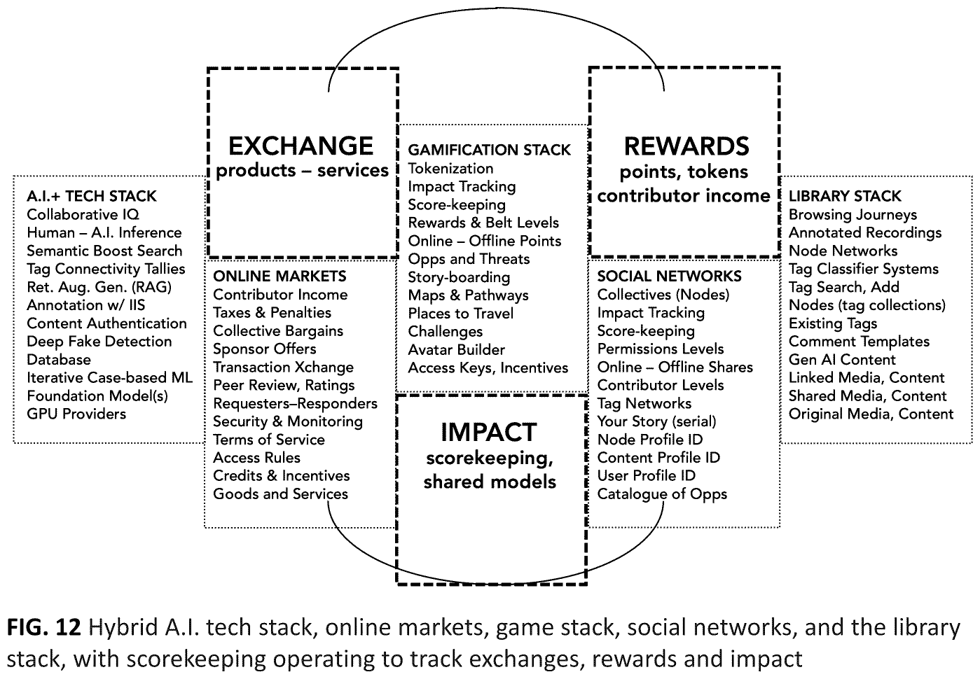

FIG. 12 summarizes the cross-functionality of the complementary embodiments. The first embodiment, described in the first half of this patent, focuses knowledge management, and how hybrid A.I. (A.I.-human iterative feedback loops) underpins an A.I. Tech Stack that enables development, classifying and sharing of content via the Library Stack, which showcases human artists collaborating with A.I. tools for writing, illustrating, animating, making music, and other arts enabled by A.I. tools. The Game stack is a core enabler for all aspects of impact tracking, scorekeeping, and exchange in this invention. A gamer encounters the game stack via access keys and incentives. Identity is a driver in any social network, and the Game Stack has a place, both for each user's cameo and for an Avatar Builder. The “scene of the action,” where the hero has tasks to perform, may be highlighted in one embodiment as Maps and Pathways or Places to Travel, both online and offline. Scorekeeping enables Impact Tracking and tallies offline points earned, validated, and records them. The Game Stack also serves Online Markets by tallying points that translate into tokens, rewards, and in some embodiments, fiat currency. Whether Rewards or Belt Levels, or other marks for levels of achievement, there are many models, from job titles to airline miles to preferred customer offers. The Game Stack connects Transaction Exchange functionality with Rewards and Impact Tracking, and also stands between, and connects online markets with social networks. Finally, the central Game Stack collects monster challenges that demand heroic effort and enables the story-boarding that co-discovers and shares real Opps and Threats that call for action. The subject invention describes a next generation social network of globally distributed local problem-solving nodes, sharing their creative results.

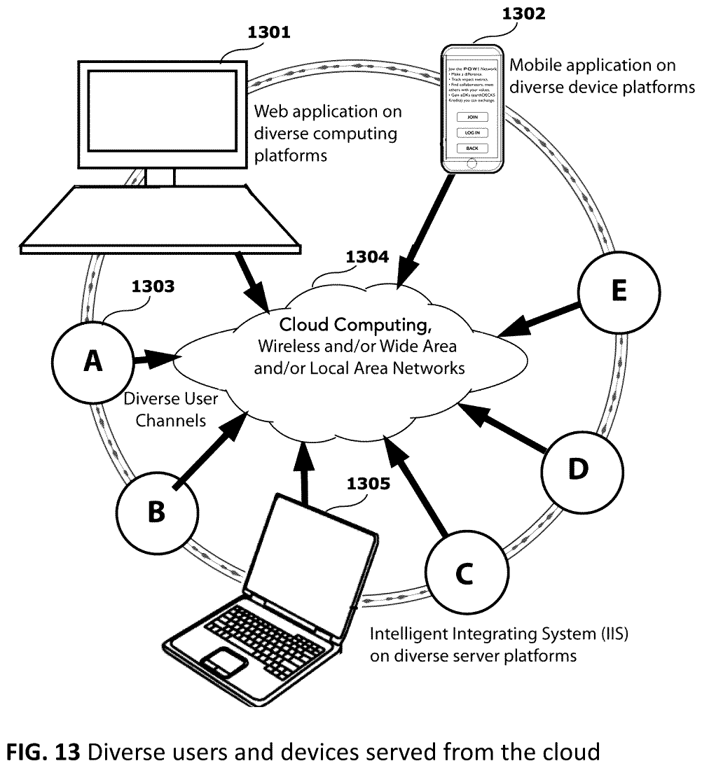

FIG. 13 illustrates a generic diagram of the subject invention, which provides a non-transitory, computer-implemented system to support distributed knowledge-sharing, rapid updating, and collaborative problem-solving wherein both click actions and natural language via web applications, mobile devices, computers or other such devices on a network, which may be in the cloud, wireless, a wide area or local area network, the internet, intranet, and, or linking diverse social networks including, but not limited to, a private network, such as a regional or topical community, gaming or competition network, a virtual private network, social or professional network, or a network of networks. FIG. 13 shows an abstracted conceptual diagram for one embodiment of the invention, a knowledge platform using a cloud computing environment, serving and receiving from diverse non-transitory devices, managing data from users with diverse profiles, belonging to different user groups, with different interests and reasons for being on the network. The subject invention networks a range of non-transitory computing systems 1301, including mobile devices 1302 connecting different groups of users (1303 A, B, C, D, E) in the cloud 1304 and, or across wireless, wide area and local area networks and server platforms 1305. FIG. 13 shows one embodiment wherein diverse groups of users 1303 receive recommendations from an Intelligent Integrating System (IIS) database in the cloud 1304.

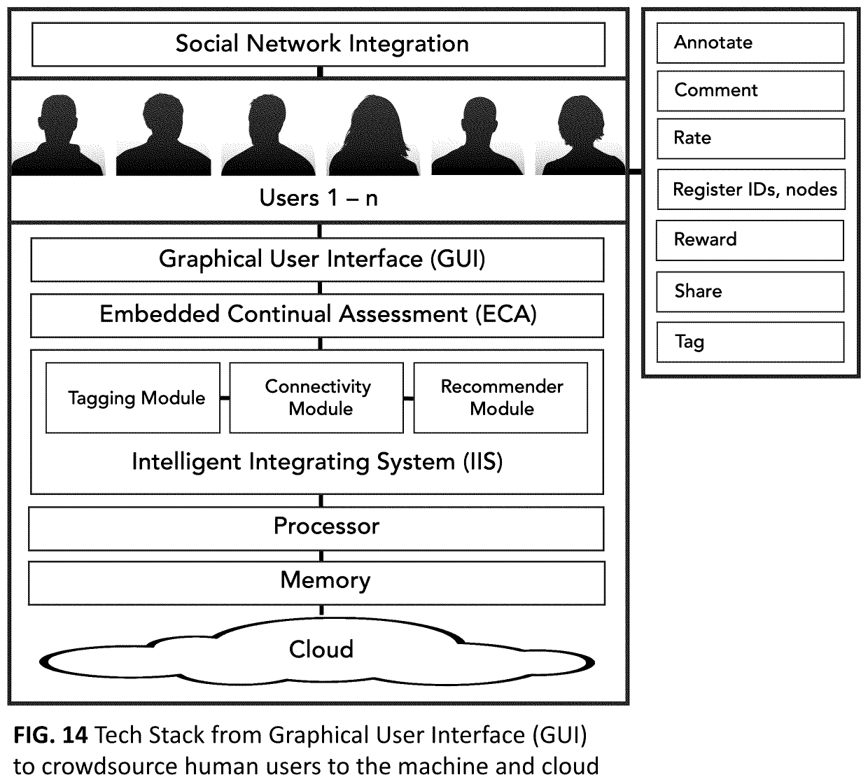

FIG. 14 illustrates the subject invention in a block diagram for a Hybrid Human-AI Machine Learning Recommender System with a network infrastructure comprising cloud, memory, and processor communicatively coupled to an Intelligent Integrating System (IIS). The IIS, which is further comprised of a human-in-the-loop tagging module, connectivity module and recommender module. This system integrates human pattern recognition with machine learning to crowdsource content tagging and make recommendations. In this embodiment, the IIS gathers inputs from users (users 1 to n) via the network, which can be any suitable wired or wireless network. Preferred network embodiments include, but are not limited to, LAN, WLAN, the Internet, point-to-point connections, or any combination thereof. The network facilitates data transmission between host computers, personal devices, mobile phone applications, video/image capturing devices, video/image servers, or any other electronic devices. This network can be local, regional, or global, including enterprise telecommunication networks, the Internet, global mobile communication networks, or any combination of similar networks. The network can also include software, hardware, or computer applications that facilitate the exchange of signals or data in any format known in the art, related art, or developed in the future. For example, if the network includes both an enterprise network and a cellular network, systems and methods such as a mobile switching gateway communicating with a computer network gateway can be employed to communicate seamlessly between the two networks. The IIS processes data through its connectivity module, which assembles metadata tags for every user, content item, resource, action, procedure, timestamp, or geo-location into a machine-readable identifier (ID). The connectivity module compares the tag strength profile in a given ID with tag strength profiles of all other IDs, including users, content items, resources, actions, procedures, nodes, timestamps, or geo-locations, or other IDs with shared attributes such that the Recommender Module can make recommendations to each user based on similar tag strength profiles. Tags with higher connectivity scores indicate greater relevance and importance within the network, suggesting a stronger basis for recommendations. The system can use a hybrid method that combines multiple techniques to compute connectivity scores, integrating semantic similarity analysis, graph theory, collaborative filtering, probabilistic modeling, and hybrid approaches to compute a composite connectivity score. This hybrid approach leverages the strengths of each individual method, providing a comprehensive and robust mechanism for evaluating the relevance and importance of tags within the network of the hybrid human-AI machine learning recommender system.

The present invention enables greater efficiency in addressing tasks, both within a geo-proximal community, and across many communities, and for problems that require rapid response on the fly, in real time, as in emergencies where traditional systems break down or prove inadequate. Problem keyword topic mapping and geo-mapping can support tracking process steps, which users may follow serially, in pre-specified, or specified-on-the-fly, sequence, or in user-selected order as circumstances require. Distributed agents (human or not) can gather virtually online to share information. Human users can register nodes online and can use these nodes to collaborate to respond to problems posted as task requests. Machine capacity to specify and log tasks applies both to project management and to the gamified embodiment. Human peer review and tagging user entry IDs and response IDs is supported by the machine recording geographical locations, timestamping actions, performing geographic and time-sensitive analysis of user needs and resources, maintaining data on capabilities to meet those needs, categorizing requests by keyword, neighborhood, city, region, or other geographically defined or keyword-topic-defined category in order to cluster responses by location and, or type, profile analysis of user IDs, and comparative clustering across geographic and keyword nodes with similar challenges and attributes where sub-routines can be specified by task requesters to the query system running in a defined region or focusing on a keyword, topic.

Scorekeeping for impact tracking in all embodiments invokes the gamification challenge, and the question of whether a Pokémon Go crowd can be enlisted to battle our real-world monster challenges, for points, tokens or fiat currency. The subject invention provides for different levels of authorship, permissions, content filtering and access, associated with the level achieved. Entitlement permissions are adjustable as the problem-solving process proceeds, ranging from confidential and anonymous to readable, open for comment, permission to edit, anonymous or credited to the contributor. Categories of permissions, and means of granting permissions, can be revised. In one embodiment of the subject invention, as a user's profile ID score rises in the system, that user earns increased levels of access and more challenging task opportunities that earn more points and credits. A user's record of achievement in the system unlocks new opportunities, higher levels of permissions and authorship, ranging from private to small groups to public, wherein all user actions, and their reach, determine user access levels, system evolution and recommendations. Nodes, here teams, whose members have earned substantial points for themselves and for the node may restrict membership to gamers who have reached their qualifying level.

In one gamified embodiment, nine belt level colors show different provider categories in an evolving social network that grows by inviting guests from the outside community to share their project(s) as challenges for the network, which can provide talent to grow the team for each project. Levels of participation are coded according to a defined award system, such as the belt system developed for modern judo, now adopted by other martial arts, including taekwondo and karate, where the beginner starts with a white belt, progressing through yellow, orange, green, blue, purple, brown, red, and finally, to the black belt of a master, such that, in addition to contributor networks in which individual profile IDs are defined by keyword categories, tags, users also rise through the system based on how their contributions are used, rated, and shared by the community. As in martial arts, each level can be designated by a colored belt or other symbol. Actions taken in the system can be recorded with color-coded icon tags that correspond to each contributor's belt level. Belt levels can run from white belt (new guest, novice) to yellow belt (guest) to orange (newly-initiated), green (newly-initiated guide), blue, purple, brown, red, and finally black belt. As players achieve higher belt levels, they retain access and entitlements of lower belt levels and can continue to perform the actions that they were able to perform at lower belt levels. The game presents increasingly difficult missions and challenges. A diversity of rewards include, but are not limited to, points, contributor tokens (CTs), credits, and incentives.

Color-coding may also be used, not only for levels but also for node IDs, as when, in one embodiment, sponsors are Green Belt Guides because of their environmental leadership. In an online environment, user avatars, rather than belts, can be represented by colored Rorschach inkblots, or color-coded rings, or in some other way that symbolizes a series of levels, or achievements and leadership with associated permissions, as for belt levels described above. In one gamified embodiment, participants (e.g. Guests or Guides) post their responses to queries and instructions or “clues” or “alerts” from other users or from the Intelligent Integrating System, which are routed to closest match user profile IDs. Task requests and recommendations may be based on the user's belt level, profile, location, actions already recorded in the system in that region, criteria about tasks that need to be performed including, but not limited to, regional priorities identified, regional organizations participating in a given quest, enablers identified, and so on. Expert users trigger the system to launch more sophisticated rules, queries, levels of participation or gameplay, such that the system rewards excellence, enabling points in the system to support user performance evaluation, which can be translated into grades for students, salary bonuses when implemented as part of an employee performance review system and into incentives and rewards when part of a gamified online program. Levels of access and entitlement permissions change as the new entrant progresses from novice through seven levels of Guides to Black Belt. User credit for sharing content can be shown both in tags and profiles and via scores and levels.

The subject invention is applied to three broad, co-dependent use cases, each of which has many specific embodiments, all use cases involving networks of distributed users and ecosystems wherein all items, processes and content are tagged. The first use case is for classifying and organizing content that is contributed, used, shared, rated, tagged and annotated by its users, as in one embodiment for annotating recordings of online presentations and discussions, such that the online recording is linked to related content and complementary knowledge resources for use in an online course and, or to support critical thinking and debate on a topic. The second use case is for project development where users participate in a distributed online ecosystem comprising a distributed network of nodes. The second use case is a transactional exchange system where requesters and responders/providers participate in an online market. This second use case may include content consumers and providers, the domain of the first use case. The second and third use cases extend the functionality of the first use case and would be implemented once the first use case has a sufficient number of users.

In all embodiments the system makes recommendations based on user preferences, click profile and queries. User entries and audit trails augment explicit preference settings with implicit preference indicators stored in computer-readable memory. Building on the basic functionality of content management, task, project, program, and distributed team management, enabled by crowd-sourcing in product and service networks, the subject invention serves diverse users, cross-referencing user profile IDs. Each user profile ID informs assessment of content relevance to that user's preferences, enabling the system to make customized recommendations. Prior patents, for which this patent is a partial continuation, use the terms channels to designate categories of users, portals to designate categories of content, and sub-portals to designate sub-categories of content. In this patent the term node has been substituted for both terms channel and portal, and the term sub-node for sub-portals. Nodes contain all “virtual labs” for all types of user IDs, content IDs, keyword IDs, project IDs, and, or all other item IDs or action IDs in the system, or a mix of tag types. Using the single term node clarifies that all items and actions are treated in the same way, sorted by their IDs, containing tags, using their node affiliation(s) indicated by node tag(s).

All embodiments of the present invention provide means to coordinate large numbers of distributed participants, crowdsourcing for tasks ranging from content rating and classifying to action and its impact tracking. Some complex projects require many tasks to be executed by distributed performers with diverse skillsets, and means to rate products and services in diverse nodes. The Intelligent Integrating System uses natural language to elicit, receive, and organize information from diverse users, nodes and to deliver information as needed in response to user requests, profiles, preferences and past usage activity in the system. Templates are used to convert natural language queries and responses into structured components that the machine can analyze, compare, cluster, integrate, search, sort to interpret by the IIS in order to deliver recommendations customized for user ID preferences and project needs.

What is claimed is:

1. A hybrid human-A.I. recommender system based on profile identifiers (IDs) defined by tags, said system comprising:
a processor;
a non-transitory storage element coupled to the processor;
encoded instructions stored in the non-transitory storage element, wherein encoded instructions, when implemented by the processor, configure the system to:
receive input of tags, wherein said tags are descriptors attached to each machine-readable identifier (ID);
attach each tag to a designated ID, wherein said ID is at least one of a user ID, action ID, content item ID, keyword ID, node ID, procedure ID, resource ID;
compute the strength of every tag attached to a given ID based on the number of occurrences of each tag in that ID to produce a tag strength profile for that ID; and
match each user ID with IDs of at least one of a user ID, action ID, content item ID, keyword ID, node ID, procedure ID, resource ID, based on comparing the tag strength profiles of their IDs.

2. The system of claim 1, wherein computing the tag strength profile for a given ID entails scanning all tags in that ID, tallying the number of times each tag appears in that ID, and prioritizing tags by number of occurrences of each tag in a given ID.

3. The system of claim 1, wherein matching entails comparing the tag strength profile of the user ID receiving recommendations with the tag strength profile of one or more IDs to be recommended.

4. The system of claim 3, wherein recommendations based on the computed and matched tag strength profiles is adjusted based on exceptional tags providing key ID profile data for at least one of age, occupation, location, node affiliation(s).

5. The system of claim 3, wherein recommendations based on the computed and matched tag strength profiles is adjusted based on semantic analysis of user natural language contributions to the system.

6. The system of claim 1, wherein recommendations is based on a partial tag strength profile using a subset of tags within an ID.

7. The system of claim 1, wherein each ID contains tags linking that ID to all other IDs in the system with that tag, making at least one of a user ID, action ID, content item ID, keyword ID, node ID, procedure ID, resource ID, timestamp tag or geo-location tag discoverable by searching any tag in an ID.

8. The system of claim 1, wherein a user ID can register a node ID to assemble other user IDs, action IDs, content item IDs, keyword IDs, node IDs, procedure IDs, resource IDs for task performance, content collection, search, discovery, sharing, record-keeping, or to inform ID clustering.

9. A hybrid human-A.I. recommender system, said system comprising:
a processor;
a non-transitory storage element coupled to the processor;
encoded instructions stored in the non-transitory storage element, wherein encoded instructions, when implemented by the processor, configure the system to:
populate a graphical user interface with a menu of content and other customized recommendations for the user profile ID, based on that user's tag strength profile;
populate the graphical user interface after the user consumes content with a format to rate that content, including at least one of a menu of icons, badges and forms so that the user can be awarded points to content, comment, keyword tag, peer review, rate and vote on content; and
tally points awarded to each ID such that when a user, having consumed a content item, awards points to that content item ID, the system automatically awards points to at least one of the user ID of the content contributor, user ID of the current content rater, and to other user IDs that have commented, peer reviewed, rated or shared that content.

10. The system of claim 9, further comprising Embedded Continual Assessment that allocates to that user ID initial points on upload, and additional points each time the content ID is rated, shared, tagged, or receives natural language comments or peer review.

11. The system of claim 9, wherein points earned for any contribution are augmented based on how much that contribution is at least one of used, shared, positively rated and peer reviewed.

12. The system of claim 10, wherein Embedded Continual Assessment tallies points earned from contributions of content and tasks performed, such that numerical points earned by any user ID can be translated into contributor tokens and, or flat currency.

13. The system of claim 9, wherein points earned can be used to define each user ID access level, incentives, opportunities, and other rewards.

14. The system of claim 9, further comprising capacity for a user ID to register an online ID for an offline contribution or task performed, confirmed by at least one of processing validation of each contribution or presenting the contribution ID for peer review, which activates Embedded Continual Assessment scorekeeping and impact tracking.

15. The system of claim 9, further comprising capacity for a user ID to attach a keyword ID tag, badge to a content ID, which not only tags that content ID with a keyword ID but also awards points to that content ID, activating Embedded Continual Assessment scorekeeping.

16. The system of claim 9, further comprising iterative cycles of Embedded Continual Assessment displaying graphical user interfaces (GUIs) and icons, badges such that bidirectional interactions from the frontend GUI and its human users to backend machine processing are mediated by tags, IDs, and nodes, crowdsourcing human prompts to train and monitor the machine learning system.

17. The system of claim 9, wherein each user ID is connected to every other ID through shared keyword tags, represented as icons that can be assembled like lego blocks to build at least one of a curriculum, gameboard, template, and other customized graphical user interfaces for browsing, navigation, and group collaboration.

18. The system of claim 9, wherein scorekeeping and timestamping are used to determine whether, and at what rate, either determined by use, or designated long term value that is not time or use dependent, items in the system are held static, upgrade or degrade and are removed from the system, with controls to prevent an ID from deletion if it is linked to other IDs that continue to be used or has exceptional tags that indicate potential future use.

19. A hybrid human-A.I. recommender system for online content annotation, said system comprising:
a processor;
a non-transitory storage element coupled to the processor;
encoded instructions stored in the non-transitory storage element, wherein encoded instructions, when implemented by the processor, configure the system to:
timestamp each user click while viewing an online recording, registered as an online project node for annotation;
link each click timestamp to proximal keywords in the recording content at the time of the click;
collect all timestamped clicks into a unique user click profile for that user ID and that content ID; and
make recommendations to that user ID based on that user's click profile.

20. The system of claim 19, wherein the capacity of a user ID to register frontend-facing nodes is complemented by the capacity of the machine to cluster backend-facing IDs and tags for analysis and, or to recommend to a human user registration of a node.

21. The system of claim 20, wherein Embedded Continual Assessment tracks total points earned by any ID in a given node, with total points earned by a node ID.

22. The system of claim 19, wherein annotations are indexed and searchable, allowing users to discover annotations, other users, and related content using keywords or other tags.

23. The system of claim 19, further comprising semantic analysis of human natural language contributions by the machine learning system.

24. The system of claim 19, further comprising capacity to integrate social media functions within a registered node ID, allowing users to perform at least one of the following functions associated with the integrated social media: follow other users, like and share annotations, or receive notifications.

25. The system of claim 19, wherein a registered node ID can contain one or more virtual labs, designated as public, private, or restricted, such that lab access restrictions define content access, and allow the user ID content contributor to move content contributed from one lab to another with different access.
